(19) United States
(12) Patent Application Publication
(10) Pub. No.: US 2024/0109989 A1
(43) Pub. Date: Apr. 4, 2024

(54) FLUOROOLEFIN-VINYL ETHER COPOLYMER IONIC FLUOROGELS AND METHODS OF USE THEREOF

(71) Applicant: THE UNIVERSITY OF NORTH CAROLINA AT CHAPEL HILL, Chapel Hill, NC (US)

(72) Inventors: Frank Albert Leibfarth, Carrboro, NC (US); Irene Mulloy Manning, Chapel Hill, NC (US); Orlando Coronell Nieto, Cary, NC (US)

(21) Appl. No.: 18/273,372

(22) PCT Filed: Jan. 21, 2022
(86) PCT No.: PCT/US22/13249

§ 371 Date: Jul. 20, 2023

Related U.S. Application Data
(60) Provisional application No. 63/140,306, filed on Jan. 22, 2021.

(51) Int. Cl. C08F 216/14

(52) U.S. Cl. CPC C08F 216/1408

(57) ABSTRACT

The present disclosure relates materials and methods related to the removal of polyfluorinated alkyl compounds from water. More specifically, the materials disclosed herein are fluoroolefin-vinyl ether copolymer containing fluorinated ionic polymer networks which can be used to remove the polyfluorinated alkyl compounds from water.

### TECHNICAL FIELD

The present disclosure relates to materials and methods related to the removal of polyfluorinated alkyl compounds from water. More specifically, the materials disclosed herein are fluorinated ionic polymer networks comprising fluoroolefin-vinyl ether copolymers as the soluble polymer precursor to the network, which can be used to remove the polyfluorinated alkyl compounds from water.

### BACKGROUND

Per- and polyfluoroalkyl substances (PFAS) are a class of over 5,000 compounds which are ubiquitous in consumer products, packaging materials, aqueous fire-fighting foams, and surfactants used in the industrial production of fluoropolymers.¹⁻³ Due to this wide use, PFAS contaminate waterways worldwide.^{4,5} Some legacy PFAS, including perfluorooctanoic acid (PFOA) and perfluorooctane sulfonic acid (PFOS), have been linked to numerous health effects.⁶⁻¹¹ As a result, the EPA has set a non-enforceable health advisory limit of 70 ng/L for combined concentrations of perfluorooctanoic acid and perfluorooctane sulfonic acid.¹² These PFAS were phased out in the United States, although they still contaminate ground and surface water worldwide. Their replacements, which include perfluoroalkyl ether acids such as hexafluoropropene-dimer acid (HFPO-DA, GenX) among other short- and long-chain PFAS, now pose many of the same risks as perfluorooctanoic acid and perfluorooctane sulfonic acid.^{4,13}

The primary challenge for developing a resin for PFAS remediation is that other organic and inorganic matter is present in water at 3-6 orders of magnitude higher concentration than PFAS.¹⁴ Conventional water remediation strategies, such as flocculation, chlorination, and ozonolysis, are ineffective to remove PFAS from water.¹⁵ Commercial water purification resins, such as granular activated carbon (GAC) and ion exchange resins, demonstrate limited success removing short-chain PFAS from water and exhibit breakthrough at moderate bed volumes.¹⁶ This is due to factors such as a lack of selectivity for PFAS, preferential binding for other organic matter in water, and artificial concentration of PFAS in water when PFAS leach from the resin. Emerging materials, such as porous polymeric resins¹⁷ and ion exchange materials that contain a fluorinated component²⁶⁻³⁰, have been used, but their results in real water remediation scenarios are unclear. For example, while porous polymeric resins¹⁷-25 demonstrate high capacity in pure water, they adsorb organic contaminants non-specifically and, thus, are prone to saturation by non-fluorinated species.

Thus, there is a need to remove polyfluorinated alkyl compounds from water to make it safer for the public. These and other challenges are addressed by the subject matter disclosed herein.

### SUMMARY

In accordance with the purpose(s) of the currently disclosed subject matter or problems to be solved by the invention, as embodied and broadly described herein, it is an object of the present invention to provide a fluorinated ionic polymer network comprising a fluoroolefin-vinyl ether copolymer and at least one crosslinking agent. In an embodiment, the fluoroolefin-vinyl ether copolymer is represented by a compound with the structure of Formula (I):

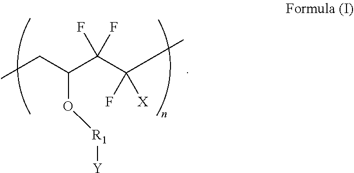

In another aspect, the subject matter described herein is directed to methods of preparing fluorinated ionic polymer networks, the methods comprising the steps of contacting the fluoroolefin-vinyl ether copolymer with the crosslinking agent to produce the fluorinated ionic polymer networks. In an embodiment, the reaction between the fluoroolefin-vinyl ether copolymer and the crosslinking agent is a nucleophilic substitution reaction.

In another aspect, the subject matter described herein is directed to methods for removing polyfluorinated alkyl compounds from water, the methods comprising the step of absorbing the polyfluorinated alkyl compounds with the fluorinated ionic polymer networks. In an embodiment, the method further comprises the step of removing the fluorinated ionic polymer network comprising the absorbed polyfluorinated alkyl compound from the water. In a further embodiment, the method comprises the step of separating the absorbed polyfluorinated alkyl compound from the fluorinated ionic polymer network.

These and other aspects are disclosed in further detail below.

### BRIEF DESCRIPTION OF THE FIGURES

FIG. 1 shows equilibrium PFAS removal by granular activated carbon (GAC) or fluorinated ionic polymer networks IF1-IF7. Water constituents: 200 mg/L NaCl and 20 mg/L humic acid; pH=6.4; Sorbent: 10 mg/L; PFAS: (PFOA, PFHxA, GenX, 1 μg L-1 each); Equilibrium time: 21 h. Error bars: Standard deviation of 3 experiments.

FIG. 2 shows regeneration and reuse of IF-2. Sorbent=20 mg, [GenX]=10 mg/L (20 mL); extraction with 400 mM methanolic ammonium acetate (20 mL). Error bars: Standard deviation of 3 experiments.

FIG. 3 shows equilibrium PFAS removal by the following fluorinated ionic polymer networks: IF-PMDTA-11, IF-PMDTA-16, IF-PMDTA-20, IF-PMDTA-30, IF-PMDTA-30q, IF-PMDTA-40, and IF-PMDTA-40q. Water constituents: 200 mg/L NaCl and 20 mg/L humic acid; pH=6.4; Sorbent: 10 mg/L; PFAS: (PFOA, PFHxA, GenX, 1μg L-1 each); Equilibrium time: 21 h.

FIG. 4 shows equilibrium PFAS removal by the following fluorinated ionic polymer networks: IF-HMTETA-15, IF-HMTETA-20, IF-HMTETA-20q, IF-HMTETA-30, IF-HMTETA-30q, IF-HMTETA-30qf, IF-HMTETA-4, IF-HMTETA-40q, and IF-HMTETA-40qd. Water constituents: 200 mg/L NaCl and 20 mg/L humic acid; pH=6.4; Sorbent: 10 mg/L; PFAS: (PFOA, PFHxA, GenX, 1 μg L-1 each); Equilibrium time: 21 h.

FIG. 5 shows equilibrium PFAS removal by the following fluorinated ionic polymer networks: IF-Me6TREN-20, IF-Me6TREN-20q, IF-Me6TREN-20qd, and IF-Me6TREN-40q. Water constituents: 200 mg/L NaCl and 20 mg/L humic acid; pH=6.4; Sorbent: 10 mg/L; PFAS: (PFOA, PFHxA, GenX, 1 μg L-1 each); Equilibrium time: 21 h.

FIG. 6 shows regeneration and reuse of IF-HMTETA-40q using organic solution. Sorbent=20 mg, [GenX]=10 mg/L (20 mL); extraction with 400 mM ammonium acetate in 50% aqueous ethanol (20 mL).

FIG. 7 shows regeneration and reuse of IF-HMTETA-40q using aqueous solution. Sorbent=20 mg, [GenX]=10 mg/L (20 mL); extraction with saturated brine (20 mL).

FIG. 8 shows a graph of the data obtained from a mini-rapid small scale column test using IF-Me6TREN-20 and Purolite 694AE as remediation materials [PFAS]0=500 ng/L each.

FIG. 9 shows a bar graph of the removal of Gen X by IF-2 at varied initial concentrations (1 ug/L to 50 mg/L). Water matrix: nanopure water or simulated natural water (20 mg/L Humic acid, 200 mg/L sodium chloride).

FIG. 10 is a picture showing the suspension reaction setup.

FIG. 11 is a picture of beads synthesized via the suspension reaction.

### DETAILED DESCRIPTION

The present invention can be understood more readily by reference to the following detailed description of the invention and the Examples included therein. It should be noted that all references mentioned throughout the disclosure are incorporated by reference herein in their entirety.

Before the present compounds, compositions, articles, systems, devices, and/or methods are disclosed and described, it is to be understood that they are not limited to specific synthetic methods unless otherwise specified, or to particular components unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

As described herein, in embodiments, are fluorinated ionic polymer networks comprising fluoroolefin-vinyl ether copolymers. These fluorinated ionic polymer networks are intended for removal of PFAS from solutions, where the fluorinated ionic polymer networks exhibit at least one benefit such as: 1) reduced cost compared with other fluorinated ionic polymer networks; 2) hydrolytic stability (i.e., they do not hydrolytically degrade in solutions such as water); 3) increased ease of synthetic scale-up due to factors such as a lower exotherm when performing the crosslinking step compared to performing a polymerization; 4) increased ease for tuning the chemical characteristics of the fluorinated ionic polymer networks; 5) improved removal of PFAS from water, especially when compared to methods such as granular activated carbon or ionic exchange resins; 6) improved removal of PFAS from the fluorinated ionic polymer network for regeneration, especially when compared to methods such as granular activated carbon or ionic exchange resins; 7) improved chemical stability, especially when in the presence of basic (i.e., pH>7) conditions; and 8) tunable particle size of the fluorinated ionic polymer network.

Recently, the inventors of the presently disclosed invention reported a series of perfluoropolyether (PFPE)-based fluorinated ionic polymer networks (also known as ionic fluorogels) (Ref. 31: Kumarasamy, E.; Manning, I. M.; Collins, L. B.; Coronell, O.; Leibfarth, F. A. Ionic Fluorogels for Remediation of Per- and Polyfluorinated Alkyl Substances from Water. ACS Cent. Sci. 2020, 6 (4), 487-792), a materials design platform which relies on a synergistic combination of a fluorophilic component (PFPE) and an electrostatic component (dimethylaminoethyl methacrylate, DMAEMA) to remove PFAS from natural water. However, these fluorinated ionic polymer networks suffered from drawbacks such as: 1) hydrolytic instability; 2) high relative cost; 3) poor solubility of the PFPE substrate, resulting in the need for expensive and environmentally harmful solvents and reaction conditions to form the fluorinated ionic polymer networks; and 4) difficult synthetic scale-up and dangerous exothermic chemical reactions.

Given the need for a scalable and chemically stable PFAS remediation technology, partially fluorinated polymers which could serve as low-cost, chemically stable, and high performance fluorophilic matrices for PFAS removal were explored. As disclosed herein, fluoroolefin-vinyl ether copolymers (FVEs) were identified as a class of polymers with tunable fluorine density (from the fluoroolefin co-monomer) and a wide variety of accessible functionality (from the vinyl ether co-monomer).³²⁻⁴⁶ FVEs are attractive materials for a multitude of applications due to their resistance to chemical, thermal, and hydrolytic degradation, imparted by the high fluorine density and alternating structure of the polymer backbone.^{39,41,47-49}

FVEs have been discovered to be excellent substrates for the development of new platform technology of chemically stable, versatile, and scalable fluorinated ionic polymer networks. The fluorinated ionic polymer networks disclosed herein comprise FVE copolymers that are chemically crosslinked into polymer networks. This platform allows the tuning of the fluorophilicity of fluorinated ionic polymer networks by varying the fluoroolefin co-monomers, the vinyl ether co-monomers, and the crosslinking agents.

Further, by varying the weight percent incorporation of each component, it is possible to tune the affinity of the resins for both legacy and emerging PFAS. The resins demonstrate advantageous properties such as fast, irreversible binding of PFAS and facile regeneration.

### A. Definitions

Listed below are definitions of various terms used to describe this invention. These definitions apply to the terms as they are used throughout this specification, unless otherwise limited in specific instances, either individually or as part of a larger group.

As used in the specification and the appended claims, the singular forms “a,” “an” and “the” include plural referents unless the context clearly dictates otherwise. Thus, for example, reference to “a monomer” or “an alkyl group” includes mixtures of two or more such monomers or alkyl groups.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. Thus, the term “about,” when referring to a value is meant to encompass variations of, in some embodiments ±10%, in some embodiments ±5%, in some embodiments ±2%, in some embodiments ±1%, in some embodiments ±0.5%, and in some embodiments ±0.1% from the specified amount, as such variations are appropriate to perform the disclosed methods or employ the disclosed compounds. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units is also disclosed. For example, if 10 and 15 are disclosed, then 11, 12, 13, and 14 are also disclosed.

References in the specification and concluding claims to parts by weight of a particular element or component in a composition denote the weight relationship between the element or component and any other elements or components in the composition or article for which a part by weight is expressed. Thus, in a compound containing 2 parts by weight of component X and 5 parts by weight of component Y, X and Y are present at a weight ratio of 2:5, and are present in such ratio regardless of whether additional components are contained in the compositions.

A weight percent (wt %) of a component, unless specifically stated to the contrary, is based on the total weight of the vehicle or composition in which the component is included.

As used herein, the terms “optional” and “optionally” mean that the subsequently described event or circumstance can or cannot occur, and that the description includes instances where said event or circumstance occurs and instances where it does not.

As used herein, the term “alkyl” refers to a straight or branched chain hydrocarbon containing from 1 to 10 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, n-decyl, and the like. The alkyl group can also be substituted or unsubstituted. Substituted alkyl groups may be substituted with groups selected from halo (i.e., fluoro, chloro, bromo, iodo), alkyl, haloalkyl, alkenyl, alkynyl, cycloalkyl, cycloalkylalkyl, aryl, arylalkyl, heterocyclo, heterocycloalkyl, hydroxyl, alkoxy (thereby creating a polyalkoxy such as polyethylene glycol), alkenyloxy, alkynyloxy, haloalkoxy, cycloalkoxy, cycloalkylalkyloxy, aryloxy, arylalkyloxy, heterocyclooxy, heterocyclolalkyloxy, mercapto. carboxy, alkylamino, alkenylamino, alkynylamino, haloalkylamino, cycloalkylamino, cycloalkylalkylamino, arylamino, arylalkylamino, heterocycloamino, heterocycloalkylamino, disubstituted-amino, ester, amide, nitro, or cyano. A “lower alkyl” group is an alkyl group containing from one to six (e.g., from one to four) carbon atoms. Non-limiting examples of alkyls include C1-C8 alkyl, C1-C6 alkyl, C1-C3 alkyl, and C1 alkyl.

As used herein, the term “polymer” refers to a relatively high molecular weight organic compound, natural or synthetic, whose structure can be represented by a repeated small unit, the monomer or repeat unit (e.g., polyethylene, rubber, cellulose). Synthetic polymers are typically formed by addition or condensation polymerization of monomers.

As used herein, the term “copolymer” refers to a polymer formed from two or more different repeating units (monomer residues). Non-limiting examples of copolymers include an alternating copolymer, a random copolymer, a block copolymer, or a graft copolymer. It is also contemplated that, in certain embodiments, various block segments of a block copolymer can themselves comprise copolymers.

As used herein, the term “oligomer” refers to a relatively low molecular weight polymer in which the number of repeating units is between two and ten, for example from two to eight, from two to six, or from two to four. In one aspect, a collection of oligomers can have an average number of repeating units of from about two to about ten, for example, from about two to about eight, from about two to about six, or form about two to about four.

As used herein, the term “crosslinked polymer” refers to a polymer having bonds linking one polymer chain to another.

As used herein, the terms “ionic fluorogel” and “fluorinated ionic polymer network” refer to a crosslinked polymer comprising a fluoroolefin-vinyl ether copolymer and at least one crosslinking agent. Examples and further characterization of the “ionic fluorogel” and “fluorinated ionic polymer network” are provided herein.

Throughout the specification, “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

As used herein, the term “heteroaliphatic” refers to aliphatic moieties in which one or more carbon atoms in the main chain have been substituted with a heteroatom. Thus, a heteroaliphatic group refers to an aliphatic chain which contains one or more oxygen, sulfur, nitrogen, phosphorus or silicon atoms, e.g., in place of carbon atoms. Heteroaliphatic moieties may be linear or branched, and saturated or unsaturated. In certain embodiments, heteroaliphatic moieties are substituted by independent replacement of one or more of the hydrogen atoms with one or more moieties including, but not limited to, aliphatic, alicyclic, heteroaliphatic, heterocyclic, aromatic, heteroaromatic, aryl, heteroaryl, alkylaryl, alkylheteroaryl, alkoxy, aryloxy, heteroalkoxy, heteroaryloxy, alkylthio, arylthio, heteroalkylthio, heteroarylthio, F, Cl, Br, I, —OH, —NO₂, and cyano.

As used herein, the terms “heterocycloalkyl” and “heterocycloaliphatic” refer to compounds which combine the properties of heteroaliphatic and cyclic compounds and include, but are not limited to, saturated and unsaturated mono- or polycyclic ring systems having 5-16 atoms wherein at least one ring atom is a heteroatom selected from O, S and N (wherein the nitrogen and sulfur heteroatoms may be optionally be oxidized), wherein the ring systems are optionally substituted with one or more functional groups, as defined herein. In certain embodiments, “heterocycloalkyl” and “heterocycloaliphatic” refer to a non-aromatic 5, 6, 7, 8, 9 or 10-membered ring or a polycyclic group wherein at least one ring atom is a heteroatom selected from O, S and N (wherein the nitrogen and sulfur heteroatoms may be optionally be oxidized).

The term “alkenyl” as used herein is a hydrocarbon group of 2 to 10 carbon atoms with a structural formula containing at least one carbon-carbon double bond. The alkenyl group can be unsubstituted or substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein. Non-limiting examples of alkenyls include C2-18 alkenyl, C2-12 alkenyl, C2-8 alkenyl, C2-6 alkenyl, and C2-3 alkenyl.

As used herein, the term “unsubstituted” refers to a moiety (such as heteroaryl, aryl, alkenyl, and/or alkyl) that is not bonded to one or more additional organic or inorganic substituent radical as described above, meaning that such a moiety is only substituted with hydrogens.

It will be understood that the structures provided herein and any recitation of “substitution” or “substituted with” includes the implicit proviso that such structures and substitution are in accordance with permitted valence of the substituted atom and the substituent, and that the substitution results in a stable compound, e.g., which does not spontaneously undergo transformation such as by rearrangement, cyclization, elimination, etc.

As used herein, the term “alkoxy,” used alone or as part of another group, means the radical —OR, where R is an alkyl group as defined herein.

As used herein, the term “halo” refers to any suitable halogen, including —F, —Cl, —Br, and —I.

As used herein, the term “thiol” and “mercapto” refers to an —SH group.

As used herein, the term “cyano” as used herein refers to a —CN group.

As used herein, the term “carboxylic acid” refers to a —C(O)OH group.

As used herein, the term “hydroxyl” refers to an —OH group. As used herein, the term “nitro” refers to an —NO₂ group.

As used herein, the term “acyl,” used alone or as part of another group, refers to a —C(O)R radical, where R is any suitable substituent such as aryl, alkyl, alkenyl, alkynyl, cycloalkyl or other suitable substituent as described herein.

As used herein, the term “alkylthio,” used alone or as part of another group, refers to an alkyl group, as defined herein, appended to the parent molecular moiety through a thio moiety, as defined herein. Representative examples of alkylthio include, but are not limited to, methylthio, ethylthio, tert-butylthio, hexylthio, and the like.

As used herein, the term “amino” means the radical —NH₂.

As used herein, the term “alkylamino” or “mono-substituted amino,” used alone or as part of another group, means the radical —NHR, where R is an alkyl group.

As used herein, the term “disubstituted amino”, used alone or as part of another group, means the radical —NRₐR_{b}, where Rₐ and R_{b} are independently selected from the groups alkyl, haloalkyl, alkenyl, alkynyl, cycloalkyl, cycloalkylalkyl, aryl, arylalkyl, heterocyclo, and heterocycloalkyl.

As used herein, the term “leaving group” has the same meaning that is generally known in the art. Accordingly, the term “leaving group” as used herein is defined as a group which is readily broken away from its union with the carbon atoms. It is one which readily joins, for example, with an active hydrogen atom to split out a compound containing the hydrogen atom and the leaving group. Leaving groups are generally electron attracting groups either because of their electronegativity or because they have an inductive effect. Leaving groups are defined throughout the art, such as in U.S. Pat. No. 4,394,519 to Carpino, et al. which is incorporated herein by reference. Non-limiting examples of leaving groups include halo (i.e., Cl, Br, and I), CN, S(R⁴)₄, S-aryl, N₃, O-aryl, O—SO₂R⁴, wherein R⁴ is lower-alkyl, aryl or aryl lower-alkyl, wherein the alkyl or aryl groups are unsubstituted, or mono- or di-substituted with halides, SO₂R₄, SOR₄, COOR₄, COR₄, CN, CF₃, or NO₂.

As used herein, the term “protecting group” is a group that is used to protect a chemical moiety, such as —OH or —SH. Protecting groups are well known in the art. For example, an oxygen protecting group refers to a moiety which masks a hydroxy group. Suitable protecting groups include those described in Green, T W; Wuts, PGM (1999), Protective Groups in Organic Synthesis, Third Edition, Wiley-Interscience, New York, 779 pp. Non-limiting examples of protecting groups include silyl ethers (e.g. TMS, TBDMS) and substituted methyl ethers (e.g., THP).

As used herein, the terms “nucleophilic compound,” “nucleophile,” and the like mean an organic compound that may be acyclic or cyclic and comprises at least one atom carrying a free electron pair, which may or may not carry a charge, preferably a nitrogen, oxygen, sulfur or phosphorus atom, or comprises a carbon atom that may donate its electron pair.

As used herein, the terms “electrophilic compound,” “electrophile,” and the like refer to a neutral or positively charged chemical species which is attracted to negative sources and which tends to accept electron pairs in order to form a chemical bond.

As used herein, the term “contacting” refers to reagents in close proximity so that a reaction may occur.

As used herein, the term “ester,” used alone or as part of another group, refers to a —C(O)OR radical, where R is any suitable substituent such as alkyl, cycloalkyl, alkenyl, alkynyl or aryl.

As used herein, the term “ether” is represented by the formula Rₐ—O—R_{b}, where Rₐ and R_{b} can be, independently, an alkyl, cycloalkyl, alkenyl, cycloalkenyl, alkynyl, cycloalkynyl, aryl, or heteroaryl group as described herein. The term “polyether” as used herein is represented by the formula —(Rₐ—O—Rₐ)ₓ-, where Rₐ and Rₐ can be, independently, an alkyl, cycloalkyl, alkenyl, cycloalkenyl, alkynyl, cycloalkynyl, aryl, or heteroaryl group described herein and “x” is an integer of from 1 to 500. Examples of polyether groups include polyethylene oxide, polypropylene oxide, and polybutylene oxide.

As used herein, the term “thioether” is represented by the formula Rₐ—S—R_{b}, where Rₐ and R_{b} can be, independently, an alkyl, cycloalkyl, alkenyl, cycloalkenyl, alkynyl, cycloalkynyl, aryl, or heteroaryl group as described herein.

As used herein, the term “amide,” used alone or as part of another group, refers to a —C(O)NRₐR_{b} radical, where Rₐ and R_{b} are any suitable substituent such as alkyl, cycloalkyl, alkenyl, alkynyl or aryl.

As used herein, the term “sulfonic acid” refers to a compound of the formula —S(O)(O)OH.

As used herein, the term “leaving group” is used herein to mean a group capable of being displaced by a nucleophile in a bimolecular nucleophilic substitution reaction. Non-limiting examples of a leaving group include halo (i.e., Cl, Br, and I), CN, S-aryl, N₃, O-aryl, and O—SO₂R⁴, wherein R⁴ is lower-alkyl, aryl or aryl lower-alkyl, wherein the alkyl or aryl groups are unsubstituted, or mono- or di-substituted with lower-alkyl, halides, SO₂R⁴, SOR⁴, COOR⁴, COR⁴, CN, CF₃, or NO₂.

The term “heteroaryl” or “heteroaromatic” refers to a monovalent aromatic radical of 5-or 6-membered rings, and includes fused ring systems (at least one of which is aromatic) of 5-20 atoms, containing one or more heteroatoms independently selected from nitrogen, oxygen, and sulfur. Examples of heteroaryl groups are pyridinyl (including, for example, 2-hydroxypyridinyl), imidazolyl, imidazopyridinyl, pyrimidinyl (including, for example, 4-hydroxypyrimidinyl), pyrazolyl, triazolyl (including, for example, 3-amino-1,2-4-triazole or 3 -mercapto-1,2,4-triazole), pyrazinyl (including, for example, aminopyrazine), tetrazolyl, furyl, thienyl, isoxazolyl, thiazolyl, oxadiazolyl, oxazolyl, isothiazolyl, pyrrolyl, quinolinyl, isoquinolinyl, tetrahydroisoquinolinyl, indolyl, benzimidazolyl, benzofuranyl, cinnolinyl, indazolyl, indolizinyl, phthalazinyl, pyridazinyl, triazinyl, isoindolyl, pteridinyl, purinyl, oxadiazolyl, triazolyl, thiadiazolyl, thiadiazolyl, furazanyl, benzofurazanyl, benzothiophenyl, benzothiazolyl, benzoxazolyl, quinazolinyl, quinoxalinyl, naphthyridinyl, and furopyridinyl. The heteroaryl groups are thus, in some embodiments, monocyclic or bicyclic. Heteroaryl groups are optionally substituted independently with one or more substituents described herein.

### B. Fluorinated Ionic Polymer Networks

The fluorinated ionic polymer networks described herein are polymeric networks comprising a fluoroolefin-vinyl ether copolymer and at least one crosslinking agent. The fluorinated ionic polymer networks are depicted structurally by the following figure.

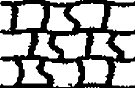

### Fluorinated Ionic Polymer Network

However, the fluorinated ionic polymer networks are not limited by this structure with respect to size, crosslinking, overall structure, etc., and the structure is merely used to physically represent the fluorinated ionic polymer networks described herein.

The fluorinated ionic polymer networks described herein utilize both fluorophilic sorption and targeted ion exchange for the removal of polyfluorinated alkyl compounds from water. The fluorinated ionic polymer networks leverage the fluorophilicity of the polyfluorinated alkyl compounds to selectively partition the polyfluorinated alkyl compounds onto a resin. The fluorinated ionic polymer networks can also utilize a tunable density of charged functional groups that can enable ion exchange and sequestration of charged polyfluorinated alkyl compounds.

The fluorinated ionic polymer network can have a positive, negative, or both positive and negative charge. As such, the fluorinated ionic polymer network can be cationic, anionic, or comprise both a cation and an anion. For example, the fluorinated ionic polymer network that comprises both a cation and an anion can comprise a quaternary ammonium and a sulfonate. In yet another aspect, the fluorinated ionic polymer network is zwitterionic.

The fluorinated ionic polymer network can be initially synthesized without being ionic (i.e., a neutral fluorogel), and the ionic nature can be formed after formation of the fluorinated polymer network, thereby generating the fluorinated ionic polymer network. In one aspect, the neutral fluorogel can be a copolymer made from a monomer comprising fluorine and a monomer comprising an ion-generating moiety. The ion-generating moiety can be made into an ionic species once the neutral fluorogel is formed, thereby producing the fluorinated ionic polymer network.

In an embodiment, the fluorinated ionic polymer network is in the form of a particle. The particle can have a mean average diameter from 5 nm to 10 cm, for example, from 100 nm to 10 cm, from 1 μm to 10 cm, from 10 μm to 10 cm, from 100 μm to 10 cm, 1 cm to 10 cm, or from 5 cm to 10 cm. In some embodiments, the particle can have a mean average diameter of less than about 10 cm, about 9 cm, about 8 cm, about 7 cm, about 6 cm, about 5 cm, about 4 cm, about 3 cm, about 2 cm, about 1 cm, about 100 mm, about 10 mm, about 100 μm, about 10 μm, about 100 nm, or less than about 100 nm. In some embodiments, the particle can have a mean average diameter from about 1 mm to about 1 cm, from about 100 mm to about 1 cm, from about 200 mm to about 1 cm, from about 300 mm to about 1 cm, from about 400 mm to about 1 cm, from about 500 mm to about 1 cm, from about 600 mm to about 1 cm, from about 700 mm to about 1 cm, from about 800 mm to about 1 cm, or from about 900 mm to about 1 cm. In some embodiments, the particle can have a mean average diameter from about 1 μm to about 1 mm, from about 10 μm to about 900 μm, from about 10 μm to about 800 μm, from about 15 μm to about 700 μm, from about 20 μm to about 650 μm, from about 25 μm to about 625 μm, from about 30 μm to about 600 μm, from about 35 μm to about 575 μm, from about 40 μm to about 550 μm, from about 45 μm to about 525 μm, from about 50 μm to about 500 μm, from about 45 μm to about 475 μm, from about 40 μm to about 450 μm, from about 35 μm to about 425 μm, from about 30 μm to about 400 μm, from about 25 μm to about 375 μm, from about 20 μm to about 350 μm, from about 15 μm to about 325 μm, from about 10 μm to about 300 μm, from about 10 μm to about 275 μm, or from about 5 μm to about 250 μm. In some embodiments, the particle can have a mean average diameter of less than about 1 mm, about 900 μm, about 850 μm, about 800 μm, about 750 pm, about 700 μm, about 650 pm, about 600 μm, about 550 μm, about 500 μm, about 450 μm, about 400 μm, about 350 μm, about 300 pm, about 250 μm, about 200 μm, about 150 pm, about 100 μm, or less than about 50 μm. In some embodiments, the particle can have a mean average diameter from about 1 nm to about 1 pm, from about 100 nm to about 1 μm, from about 200 nm to about 1 μm, from about 300 nm to about 1 μm, from about 400 nm to about 1 μm, from about 500 nm to about 1 μm, from about 600 nm to about 1 μm, from about 700 nm to about 1 μm, from about 800 nm to about 1 pm, or from about 900 nm to about 1 μm.

In an embodiment, the particle can have a size that is larger than a predetermined size, which can be based on the size of pores in a filter. For example, the filter can have a pore size of 1 μm. Thus, the particles should have a size of more than 1 μm so they can be collected by the filter.

In an embodiment, the fluorinated ionic polymer network can be a membrane or part of a membrane. For example, the fluorinated ionic polymer network can be particles that are filled into a cartridge, a paced resin bed, a column, a water filtration device, or a sampling device.

### 1. Fluoroolefin-Vinyl Ether Copolymer

The fluoroolefin-vinyl ether copolymer is represented by a repeat unit with the structure of Formula (I):

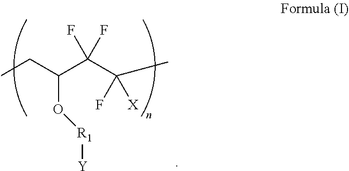

In some embodiments, in the fluoroolefin-vinyl ether copolymer of Formula (I), Y is, in each instance, absent, a leaving group or a leaving group precursor, wherein
the leaving group is selected from the group consisting of halo (i.e., Cl, Br, and I), CN, S-aryl, N₃, O-aryl, and O—SO₂R⁴, wherein R⁴ is lower-alkyl, aryl or aryl lower-alkyl, wherein the alkyl or aryl groups are unsubstituted, or mono- or di- substituted with halides, SO₂R^{4 ,} SOR⁴, COOR⁴, COR⁴, CN, CF₃, or NO₂, and
the leaving group precursor is a group capable of being converted into a leaving group, such as —SH, —OH, —SR⁵, or —OR⁵, wherein R⁵ is a protecting group,
n is an integer from 1-2000,
R¹ is, in each instance, independently chosen from substituted or unsubstituted C1-C10 alkyl, substituted or unsubstituted aryl, substituted heteroaryl, substituted cycloalkyl, wherein the substituted or unsubstituted C1-C10 alkyl may further comprise an ether, amide, ester, amine, thioether, or a combination thereof, and

X is, in each instance, chosen from —F, —Cl, Br, —CF₃, —CF₂CF₃, and —CF₂H.

In some embodiments, the fluoroolefin-vinyl ether copolymer of Formula (I) is commercially available. Exemplary commercially available fluoroolefin-vinyl ether copolymer of Formula (I) include, but should be limited to, LUMIFLON® (e.g., Lumiflon LF916F, LF9721, etc.).

It is to be understood that for each repeat unit within the polymeric structure of Formula (I), each respective repeat unit itself may be the same or different than the preceding or following repeat unit in the polymeric structure. For example, in some embodiments, in each repeat unit X is —Cl. As another example, in some embodiments, in one repeat unit le is ethyl and Y is —Cl while in another repeat unit R¹ is isopropyl and Y is absent. In this example, the repeat units may be repeating or alternating, or randomly present in the copolymer. These and further examples will be presented further herein.

In an embodiment, n is an integer selected from 1-2,000, for example, from 1-1000, 1-500, 1-250, 1-100, or 1-50. In some embodiments, n is in a range from 50-150, from 25-300, or from 10-500.

In an embodiment, R¹ is a substituted or unsubstituted C1-C10 alkyl. In a further embodiment, R¹ is a substituted C1-C10 alkyl, such as substituted C2, C3, C4, C5, C6, C7, C8, C9, or C10 alkyl. In some embodiments, R¹ is substituted with a halogen or hydroxyl. In some embodiments, R¹ is a C2-C4 substituted with a halogen or hydroxyl. In some embodiments, R¹ is ethyl substituted with halogen or hydroxyl. In some embodiments, R¹ is —CH₂CH₂Cl, —CH₂CH₂OH, or —(CH₂)₄OH. In a still further embodiment, the substituted C1-C 10 alkyl is substituted with F.

In an embodiment, le is an unsubstituted C1-C10 alkyl. In some embodiments, R¹ is a C2-C6 alkyl. In a further embodiment, R¹ is an ethylene group, as depicted in the compound of Formula (II):

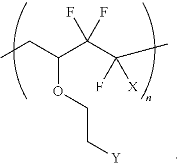

wherein n, m, R², Y, and X are defined as above.

In some embodiments, le is a branched C1-C6 alkyl. In some embodiments, R¹ is isobutyl. In some embodiments, R¹ is isobutyl and Y is absent.

In an embodiment, X is —Cl or CF₃.

In embodiments where in at least one instance Y is a leaving group, Y may be selected from the group consisting of halo (i.e., Cl, Br, and I), CN, S-aryl, N₃, O-aryl, and O—SO₂R⁴, wherein R⁴ is lower-alkyl, aryl or aryl lower-alkyl, wherein the alkyl or aryl groups are unsubstituted, or mono- or di-substituted with halides, SO₂R⁴, SOR⁴, COOR⁴, COR⁴, CN, CF₃, or NO₂. In some embodiments, the leaving group is Cl, Br, or O—SO₂R⁴, wherein R⁴ is —CH₃ or —PhCH₃. In an embodiment, Y is a halogen. In a still further embodiment, Y is —Cl.

In some embodiments, Y is a leaving group precursor. In these embodiments, the leaving group precursor is a group capable of being converted into a leaving group, such as —SH, —OH, —SR⁵, or —OR⁵, wherein R⁵ is a protecting group.

The fluoroolefin vinyl-ether copolymers have molecular weights in the range from about 1 kg/mol to about 250 kg/mol, from about 5 kg/mol to about 50 kg/mol, or about 15 kg/mol to about 30 kg/mol. In some embodiments, the fluoroolefin vinyl-ether copolymers have molecular weights of about 10 kg/mol, about 15 kg/mol, about 20 kg/mol, about 25 kg/mol, about 30 kg/mol, about 35 kg/mol, about 40 kg/mol, about 45 kg/mol, about 50 kg/mol, about 75 kg/mol, or about 100 kg/mol.

In some embodiments, in the fluoroolefin-vinyl ether copolymer of Formula (I), Y is, in each instance, absent, a nucleophilic group or a nucleophilic group precursor, wherein
the nucleophilic group is selected from the group consisting of —SH, —OH, —NH₂, —NHR, and —NRₐR_{b}, and
the nucleophilic group precursor is a group capable of being converted into a nucleophilic group, where the nucleophilic group precursor is selected from the group consisting of —SR⁵, —OR⁵, and —NHR⁵ wherein R⁵ is a protecting group,

n is an integer from 1-2000,

R¹ is, in each instance, independently chosen from substituted or unsubstituted C1-C10 alkyl, substituted or unsubstituted aryl, substituted heteroaryl, substituted cycloalkyl, wherein the substituted or unsubstituted C 1 -C10 alkyl may further comprise an ether, amide, ester, amine, thioether, or a combination thereof, and

X is, in each instance, chosen from —F, —Cl, —CF₃, —CF₂CF₃, and —CF₂H.

### 2. Crosslinking Agent

The fluorinated ionic polymer networks described herein comprise at least one crosslinking agent. More specifically, the crosslinking agents comprise functionality which reacts with the fluoroolefin vinyl-ether copolymer to form the fluorinated ionic polymer network. The reactive functionality in the crosslinking agent may be nucleophilic or electrophilic in nature.

In embodiments where the crosslinking agent contains nucleophilic functionality, the crosslinking agent comprises two or more nucleophilic moieties. Thus, the crosslinking agent is a nucleophilic compound which is an organic hydrocarbon compound that contains a backbone that may be acyclic or cyclic and comprises at least two atoms carrying a free electron pair, which may or may not carry a charge, and are the nucleophilic moieties. The nucleophilic moieties themselves are not particularly limited. The nucleophilic moieties are preferably a nitrogen, oxygen, sulfur or phosphorus atom. Thus, nucleophilic moieties as structural features in the crosslinking agent may be alcohols, thiols, amines, and the like. The amines may be substituted, so that in addition to primary amines (i.e., —NH₂), there may be mono-substituted amines, used alone or as part of another group (i.e., —NHR, where R is an alkyl group), or di-substituted amines, used alone or as part of another group, (i.e., —NRₐR_{b}, where Rₐ and R_{b} are independently selected from the groups alkyl, haloalkyl, alkenyl, alkynyl, cycloalkyl, cycloalkylalkyl, aryl, arylalkyl, heterocyclo, and heterocycloalkyl). In an embodiment, the nucleophiles are selected from the groups consisting of —SH, —OH, —NH₂, —NHR, —NRₐR_{b}, and any combination thereof. In an embodiment, the nucleophiles are —OH. In another embodiment, the nucleophiles are —NRₐR_{b}.

The backbone of the crosslinking agent containing two or more nucleophilic atoms may be aliphatic, heteroaliphatic, cycloaliphatic, heterocycloaliphatic, aromatic, heteroaromatic, or a combination thereof. In an embodiment, the backbone of the crosslinking agent is heteroaliphatic. The heteroaliphatic crosslinking agent backbone may be linear or branched. The heteroatoms in the backbone of the heteroaliphatic crosslinking agent may be N, S, O, or any combination thereof. In an embodiment, the heteroaliphatic group is an aliphatic chain which contains one or more oxygen, sulfur, nitrogen, or phosphorus, e.g., in place of carbon atoms. The heteroatoms in the heteroaliphatic crosslinking agent backbone may be nucleophilic or non-nucleophilic. For example, the heteroatoms may be nucleophilic groups such as —OH or —NHRₐR_{b} groups or the heteroatoms may be non-nucleophilic groups such as an ether (i.e., R—O—R, wherein, as an example, R is an alkyl group).

In an embodiment, the heteroaliphatic crosslinking agent comprises at least two nucleophilic —OH groups. In a further embodiment, the heteroaliphatic crosslinking agent comprises oxygen atoms in the aliphatic chain (i.e., backbone) in place of carbon atoms. In a further embodiment, the backbone of the crosslinking agent is substituted. In an embodiment, the backbone of the crosslinking agent is a substituted heteroaliphatic that is substituted with F. In an embodiment, the backbone of the crosslinking agent is a fluorinated ether such as fluorinated tetraethylene glycol (i.e., 1H,1H,11H,11H-perfluoro-3,6,9-trioxaundecane-1,11-diol).

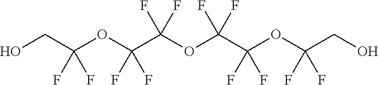 [SMILES: OCC(F)(F)OC(F)(F)C(F)(F)OC(F)(F)C(F)(F)OC(F)(F)CO]

In some embodiments, the crosslinking agent is a bifunctional perfluoropolyether (PFPE) with hydroxyl end groups, such as Fluorolink®E10H (Cas No. 162492-15-1).

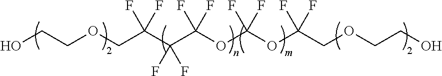

The above crosslinking agents are examples of crosslinking agent with a fluorinated ether backbone and it would be understood that the crosslinking is not limited thereto.

In an embodiment, the heteroaliphatic crosslinking agent backbone comprises at least two nucleophilic —NH₂, —NHR, or —NRₐR_{b} groups. In a further embodiment, the heteroaliphatic crosslinking agent backbone comprises nitrogen atoms in the aliphatic chain in place of carbon atoms. In a further embodiment, the crosslinking agent backbone is substituted. In an embodiment, the crosslinking agent backbone comprises nitrogen atoms in the aliphatic chain in place of carbon atoms and has at least two —NRₐR_{b} nucleophilic groups.

In an embodiment, the crosslinking agent is selected from the group consisting of TMEDA, PMDETA, HMTETA, PEI, TETA, TREN, and Me6-TREN.

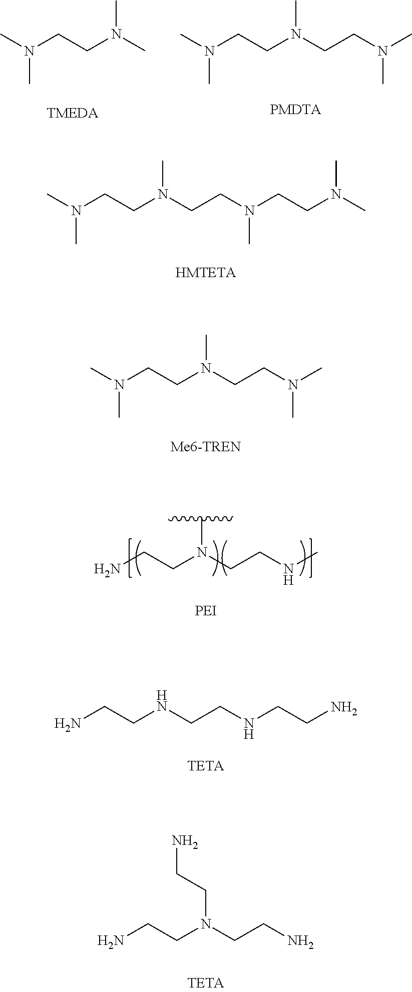

In some embodiments, the crosslinking agent is selected from the group consisting of TMEDA, PMDETA, HMTETA, and Me6-TREN.

In an embodiment, multiple crosslinking agents are used in preparing the ionic fluorogel. For example, an oxygen-containing crosslinking agent and a nitrogen-containing crosslinking agent may be used. In an embodiment, both TMEDA and PFPE are used as crosslinking agents to form a fluorinated ionic polymer network comprising a compound of Formula (I), TMEDA, and PFPE. In one embodiment, both Me6-TREN and TMEDA are used as crosslinking agents to form a fluorinated ionic polymer network comprising a compound of Formula (I), Me6-Tren, and TMEDA. In another embodiment, both Me6-TREN and HMTETA are used as crosslinking agents to form a fluorinated ionic polymer network comprising a compound of Formula (I), Me6-Tren, and HMTETA. In another embodiment, both Me6-TREN and PMDTA are used as crosslinking agents to form a fluorinated ionic polymer network comprising a compound of Formula (I), Me6-TREN, and PMDTA.

In some embodiments, the reactive functionality in the crosslinking agent is an electrophilic moiety.

In embodiments where the crosslinking agent contains electrophilic functionality, the crosslinking agent comprises two or more electrophilic moieties. Thus, the crosslinking agent is an electrophilic compound which is an organic hydrocarbon compound that may be acyclic or cyclic and comprises at least two electrophilic moieties. The electrophilic moieties themselves are not particularly limited. The electrophilic moieties are preferably a halo (i.e., Cl, Br, and I), isocyanate (i.e., NCO), CN, S-aryl, N₃, O-aryl, and O—SO₂R⁴, wherein R⁴ is lower-alkyl, aryl or aryl lower-alkyl, wherein the alkyl or aryl groups are unsubstituted, or mono- or di- substituted with halides, SO₂R⁴, SOR⁴, COOR⁴, COR⁴, CN, CF₃, or NO₂. In some embodiments, the electrophilic crosslinking agent is selected from the group pictured below, where R³ can be an aliphatic, cycloaliphatic, aromatic, etc.

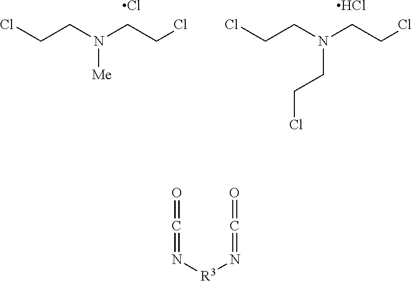

In some embodiments, the electrophilic crosslinking agent contains a fluorinated ether backbone and is selected from the group pictured below, where Z is an electrophilic moiety as shown below, but is not limited thereto.

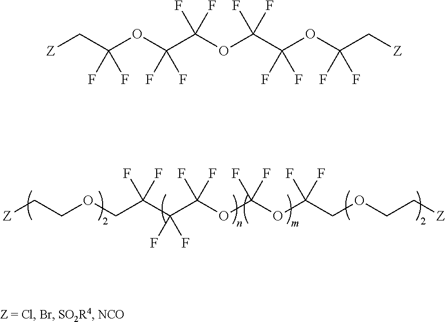

In some embodiments, the electrophilic crosslinking agent is a mesylated 1H,1H,11H,11H-perfluoro-3,6,9-trioxaundecane-1,11-diol, wherein Z is SO₂CH₃. In some embodiments, the electrophilic crosslinking agent is a mesylated Fluorolink®E10-H, wherein Z is SO₂CH₃.

### 3. Fluorinated Ionic Polymer Networks

The fluorinated ionic polymer networks, comprising the fluoroolefin-vinyl ether and at least one crosslinking agent, may be depicted with the structure of Formula (III):

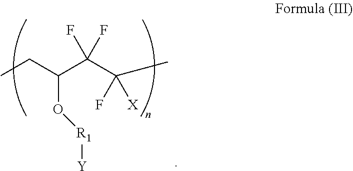

wherein,

Y is, in each instance, a crosslinking agent, absent, a leaving group, or a leaving group precursor, provided that in at least one instance Y is the crosslinking agent, wherein
the crosslinking agent comprised nucleophilic or electrophilic moieties prior to incorporation into the fluorinated ionic polymer network,
the leaving group is selected from the group consisting of halo (i.e., Cl, Br, and I), CN, S-aryl, N₃, O-aryl, and O—SO₂R⁴, wherein R⁴ is lower-alkyl, aryl or aryl lower-alkyl, wherein the alkyl or aryl groups are unsubstituted, or mono- or di- substituted with halides, SO₂R⁴, SOR⁴, COOR⁴, COR⁴, CN, CF₃, or NO₂, and
the leaving group precursor is a group capable of being converted into a leaving group, such as —SH, —OH, —SR⁵, or —OR⁵, wherein R⁵ is a protecting group,

n is an integer from 1-2000,

R¹ is, in each instance, independently chosen from substituted or unsubstituted C1-C10 alkyl, substituted or unsubstituted aryl, substituted heteroaryl, substituted cycloalkyl, wherein the substituted or unsubstituted C1-C10 alkyl may further comprise an ether, amide, ester, amine, thioether, or a combination thereof, and

X is, in each instance, chosen from —F, —Cl, —CF₃, —CF₂CF₃, and —CF₂H.

In some embodiments, the crosslinking agent is a heteroaliphatic crosslinking agent comprising nucleophilic moieties, and the nucleophilic moieties are each independently selected from the group consisting of —OH, —SH, —NH₂, —NHR, —NRₐR_{b}, and a nitrogen-containing heterocycle, where Rₐ and R_{b} are independently selected from the groups alkyl, haloalkyl, alkenyl, alkynyl, cycloalkyl, cycloalkylalkyl, aryl, arylalkyl, heterocyclo, and heterocycloalkyl. In some embodiments, the nitrogen-containing compound is a heteroaryl containing at least one nitrogen atom. Exemplary nitrogen-containing heterocycles include, but should not be limited thereto, imidazole, triazole, tetrazole, oxazole, thiazole, pyrrole, isothiazole, and isoxazole. In some embodiments, the nitrogen-containing compound is a heterocycloalkyl containing at least one nitrogen atom.

In some embodiments, the nucleophilic moieties are —NRₐR_{b}, where Rₐ and R_{b} are alkyl.

In some embodiments, the crosslinking agent is selected from the group consisting of N,N,N′,N′-tetramethylethylenediamine, N,N,N′,N″,N″ -pentamethyldiethylenetriamine, 1,1,4,7,10,10-hexamethyltriethylenetetramine, and tris[2-(dimethylamino)ethyl]amine, and a combination thereof.

In some embodiments, R¹ in each instance is independently chosen from substituted or unsubstituted C1-C10 alkyl. In some embodiments, R¹ is in each instance is independently chosen from unsubstituted C1-C10 alkyl. In some embodiments, X is Cl or CF₃. In some embodiments, R¹ is in each instance is independently chosen from unsubstituted C1-C10 alkyl and X is Cl or CF₃. In some embodiments, X is Cl. In some embodiments, R¹ is in each instance is independently chosen from unsubstituted C1-C10 alkyl and X is Cl.

In some embodiments, Y in each instance is independently chosen from absent, —O—SO₂R⁴ and —Cl. In some embodiments, Y in each instance is independently chosen from absent, —O—SO₂R⁴, wherein R⁴ is Me.

In some embodiments, R¹ in each instance is ethyl. In some embodiments, X is Cl, and each instance of Y is independently chosen from being absent, —O—SO₂Me, and —Cl. In some embodiments, R¹ in each instance is ethyl, X is Cl, and each instance of Y is independently chosen from being absent, —O—SO₂Me, and —Cl. In some embodiments, Y in each instance is selected from —O—SO₂Me, and —Cl. In some embodiments, R¹ in each instance is ethyl, X is Cl, and Y in each instance is selected from —O—SO₂Me, and —Cl. In some embodiments, Y in each instance is —Cl. In some embodiments, R¹ in each instance is ethyl, X is Cl, and Y in each instance is —Cl.

In some embodiments, R¹ in at least one instance is ethyl. In some embodiments, R¹ in at least one instance is ethyl, X is Cl, and each instance of Y is independently chosen from being absent, —O—SO₂Me, and —Cl. In some embodiments, each instance of Y is chosen from being absent and —O—SO₂Me. In some embodiments, R¹ in at least one instance is ethyl, X is Cl, and each instance of Y is chosen from being absent and —O—SO₂Me.

In some embodiments, Y is independently chosen from being absent and a crosslinking agent. In some embodiments, Y is independently chosen from being absent and a crosslinking agent and R¹ is independently chosen from unsubstituted C1-C10 alkyl. In some embodiments, Y is independently chosen from being absent and a crosslinking agent, R¹ is independently chosen from unsubstituted C1-C10 alkyl and X is Cl.

In some embodiments, the crosslinking agent is selected from the group consisting of N,N,N′,N′-tetramethylethylenediamine (TMEDA), tris[2-(dimethylamino)ethyl]amine, 1,1,4,7,10,10-hexamethyltriethylenetetramine, and a combination thereof. In some embodiments, R¹ in at least one instance is ethyl, and X is Cl. In some embodiments, the crosslinking agent is 1,1,4,7,10,10-hexamethyltriethylenetetramine, and R¹ in each instance is ethyl. In some embodiments, R¹ in at least one instance is ethyl and the crosslinking agent is N,N,N′,N′-tetramethylethylenediamine (TMEDA).

In some embodiments, the nucleophilic moieties of the crosslinking agent are —OH groups. In some embodiments, the crosslinking agent has a backbone which comprises at least one oxygen atom. In some embodiments, the backbone of the crosslinking agent is substituted. In some embodiments, the backbone of the crosslinking agent is substituted with —F. In some embodiments, the crosslinking agent is 1H,1H,11H,11H-perfluoro-3,6,9-trioxaundecane-1,11-diol or Fluorolink® E10H.

In an embodiment, at least one crosslinking agent in Formula (III) can carry one or more cationic or anionic charges. In some embodiments, the crosslinking agent in Formula (III) carries one or more cationic charges. In some embodiments, the cationic charges are quarternized nitrogen atoms present in the backbone of the crosslinking agent. In some embodiments the nitrogen atoms present in the backbone are quarternized with a methyl substituent. In some embodiments, only a portion of the nitrogen atoms present in the backbone of the crosslinking agent are quarternized (and carry a positive charge). In some embodiments, all of the nitrogen atoms present in the backbone of the crosslinking agent are quarternized.

### C. Methods Of Preparing The Fluorinated Ionic Polymer Networks

The subject matter described herein also comprises methods of preparing the fluorinated ionic polymer networks. In a first step of the method, a polymerization of olefin-containing compounds is performed. In an embodiment, the polymerization is terpolymerization of three different olefin-containing monomers. In an embodiment, the polymerization comprises two different monomers. The polymerization results in the formation of the fluoroolefin-vinyl ether copolymer (FVE).

In an embodiment, two olefin-containing monomers, such as the vinyl ether of Formula (IV) and the fluoroolefin of Formula (V) are combined to form the fluoroolefin-vinyl ether copolymer for Formula (I), as depicted in Scheme 1 below.

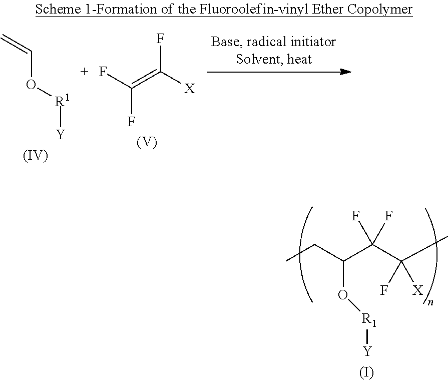

In an embodiment, three olefin-containing monomers are combined to form a fluoroolefin-vinyl ether copolymer, as depicted in Scheme 2 below.

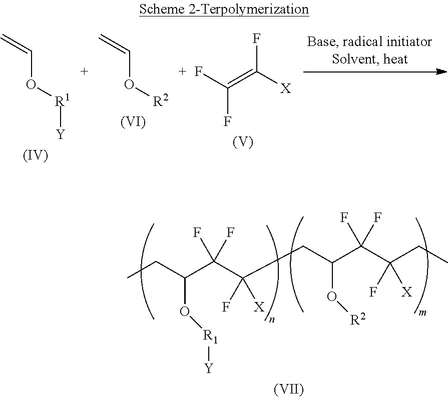

It is to be understood that for each repeat unit within the fluoroolefin-vinyl ether copolymer of Formula (VII), each repeat unit may be the same or different than the preceding or following repeat unit in the polymeric structure. For example, in some embodiments, the repeat units may be as depicted, the repeat units designated as “n” repeat units may be adjacent, the repeat units designated as “m” may be adjacent, or any combination thereof.

In Schemes 1 and 2 pictured above, in some embodiments,
n is an integer from 1-2000,
m is an integer from 1-2000,
R¹ is, in each instance, independently chosen from substituted or unsubstituted C1-C10 alkyl, substituted or unsubstituted aryl, substituted heteroaryl, substituted cycloalkyl, wherein the substituted or unsubstituted C1-C10 alkyl may further comprise an ether, amide, ester, amine, thioether, or a combination thereof,
R² is, in each instance, independently chosen from substituted or unsubstituted C1-C10 alkyl, substituted or unsubstituted aryl, substituted heteroaryl, substituted cycloalkyl, wherein the substituted or unsubstituted C1-C10 alkyl may further comprise an ether, amide, ester, amine, thioether, or a combination thereof, and

X is, in each instance, chosen from —F, —Cl, —CF₃, —CF₂CF₃, and —CF₂H.

In some embodiments, the compounds of Formulae (I), (IV), and (VII) contain electrophilic moieties, such that Y is, in each instance, absent, a leaving group, or a leaving group precursor,
wherein the leaving group is selected from the group consisting of halo (i.e., Cl, Br, and I), CN, S-aryl, N₃, O-aryl, and O—SO₂R⁴, wherein R⁴ is lower-alkyl, aryl or aryl lower-alkyl, wherein the alkyl or aryl groups are unsubstituted, or mono- or di- substituted with halides, SO₂R⁴, SOR⁴, COOR⁴, COR⁴, CN, CF₃, or NO₂, and
the leaving group precursor is a group capable of being converted into a leaving group, such as —SH, —OH, —SR⁵, or —OR⁵, —SR⁵, or NHR⁵, wherein R⁵ is a protecting group.

In some embodiments, the compounds of Formulae (I), (IV), and (VII) contain nucleophilic moieties, such that Y is, in each instance, absent, a nucleophile, or nucleophile precursor, wherein
the nucleophile is selected from the group consisting of —SH, —OH, —NH₂, —NHR, and —NRₐR_{b}, and
the nucleophile precursor is a group capable of being converted into a nucleophile, such as —OR⁵, —SR⁵, or NHR⁵, wherein R⁵ is a protecting group.

In an embodiment, R¹ is ethyl and Y is OH. In another embodiment, R¹ is ethyl and Y is Cl.

In an embodiment, R¹ is independently selected from a substituted C1-C10 alkyl and an unsubstituted C1-C10 alkyl, and Y is halo or —O—SO₂R⁴. In some embodiments, R⁴ is methyl.

In and embodiment, R¹ in at least one instance is ethyl and Y is Cl or —O—SO₂R⁴. In some embodiments, R⁴ is methyl.

In an embodiment, the polymerization is performed in the presence of a base. In some embodiments, the base is a carbonate base, such as potassium carbonate.

In an embodiment, the polymerization is performed in the presence of a radical initiator. The radical initiator is not particularly limited and is understood in the art. For example, the radical initiator may be a peroxide, such as lauroyl peroxide.

In an embodiment, the fluoroolefin-vinyl ether copolymer is commercially available. In some embodiments, the commercially available fluoroolefin-vinyl ether copolymer has a general formula (VIII) such as:

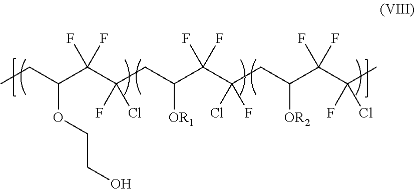

wherein R¹ and R² are, in each instance, independently chosen from substituted or unsubstituted C1-C10 alkyl group. In some embodiments, R¹ and R² are, in each instance, independently chosen from substituted or unsubstituted C1-C4 alkyl group. In some embodiments, R¹ and R² are the same alkyl group. In some embodiments, R¹ and R² are different alkyl groups.

Exemplary commercially available fluoroolefin-vinyl ether copolymers include, but should not be limited to, copolymers sold under the brand name of LUMIFLON®. For example, Lumiflon LF916F and LF9721. Grades of these copolymers have different alcohol-containing co-monomer content and are prized for the chemical stability under harsh environmental conditions.

In the next step of the synthetic method, the fluoroolefin-vinyl ether copolymer compound of Formulae (I) or (VII) is contacted with the at least one or more crosslinking agents in the presence of a base, a nucleophilic substitution additive, and an ion complexing agent, at a requisite temperature for a requisite period of time, where X, Y, R¹, R², n, and m are defined as in any of the embodiments above. With regard to fluoroolefin-vinyl ether copolymer compound of Formula (VII) the —OH is modified to a leaving group selected from a halogen (i.e., Cl, Br, F, I) or a sulfonate group —SO₂R₄, wherein R4 is lower-alkyl, aryl, or aryl lower-alkyl prior to the contacting step with the crosslinking agent. This results in the formation of the fluorinated ionic polymer network.

In some embodiments, without being bound by theory, the reaction that occurs between the fluoroolefin-vinyl ether copolymer and the crosslinking agent is a nucleophilic substitution reaction. This synthetic step is depicted using the compound of Formula (I) in Scheme 3.

In some embodiments, the fluoroolefin-vinyl ether copolymer contains a leaving group and the at least one crosslinking agent contains nucleophilic moieties. In some embodiments, the fluoroolefin-vinyl ether copolymer contains nucleophilic moieties and the at least one crosslinking agent contains a leaving group.

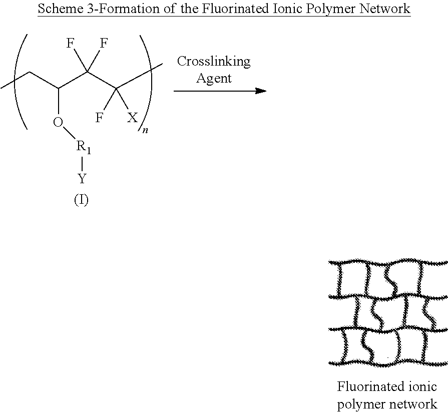

In an embodiment, at least one crosslinking agent is present in the reaction of Scheme 3 in an amount of about 10 mol %, about 20 mol %, about 30 mol %, about 40 mol %, about 50 mol %, about 60 mol %, about 70 mol %, about 80 mol %, about 90 mol %, or about 100 mol % in relation to the repeat unit concentration in the fluoroolefin-vinyl ether copolymer present in the reaction. In an embodiment, the crosslinking agent is present in the reaction of Scheme 3 in an amount of about 40 mol % in relation to the amount of fluoroolefin-vinyl ether copolymer present in the reaction.

In an embodiment, two crosslinking agents (a first crosslinking agent and a second crosslinking agent) can be present to form a fluorinated ionic polymer network. The amount of each crosslinking agent can vary. In some embodiments, the two crosslinking agents are present at a ratio of about 1:5 to about 5:1, about 1:4 to about 4:1, about 1:3 to about 3:1, about 2:3 to about 3:2, about 1:2 to about 2:1, or about 1:1 wt % ratio of the first crosslinking agent: second crosslinking agent.

In an embodiment, the base employed during the contacting step of the fluoroolefin-vinyl ether copolymer with the at least one or more crosslinking agent is a tertiary amine, such as N,N-diisopropylethylamine (i.e., DIEA or Hunig's base), but should not be limited thereto. In an embodiment, the nucleophilic substitution additive functions to facilitate the contacting step of the fluoroolefin-vinyl ether copolymer with the at least one crosslinking agent as is depicted in the reaction in Scheme 4. In an embodiment, the nucleophilic substitution additive is sodium iodide (NaI) but should not be limited thereto. In an embodiment, the ion complexing agent is a crown ether, such as 15-crown-5 but should not be limited thereto. A skilled artisan would generally be aware of suitable nucleophilic substitution additives and complexing agents that can be employed in the contacting step.

In an embodiment, the formed fluorinated ionic polymer network can be further modified by introducing one or more anionic or cationic charges into the network. For example, in some embodiments, the fluorinated ionic polymer network can be modified to include one or more anionic charges. In some embodiments, the fluorinated ionic polymer network can be modified to include one or more cationic charges. In some embodiments, the one or more cationic charges can be introduced into the fluorinated ionic polymer network by alkylating one or more nitrogen atoms present in the at least one or more crosslinking agent of the fluorinated ionic polymer. See Scheme 5 as an example, where the one or more nitrogen atoms present in the at least one or more crosslinking agent of the fluorinated ionic polymer are alkylated with post-crosslinking agent methyl iodide (MeI) to generate quarternary nitrogen atoms (i.e., a cationic charges), although the post-crosslinking agent should not be limited thereto. Other exemplary post-crosslinking agents include 1-iodoethane, 1-iodopropane, 1-iodobutane, 1-iodohexane, 1-iodooctane, 1,2-diiodoethane, 1,5-diiodipentane, or 1-perfluorooctyl iodide. In some embodiments, all of the nitrogen atoms are alkylated to afford quarternary nitrogen atoms. In some embodiments, only a portion of the nitrogen atoms are alkylated to afford quarternary nitrogen atoms.

In an embodiment, the contacting step of the fluoroolefin-vinyl ether copolymer with the crosslinking agent occurs in a suspension or emulsion where the fluoroolefin-vinyl ether copolymer and the crosslinking agent are dissolved in an organic solvent and slowly added to an aqueous solution that contains a base at a rate that avoids precipitation of the fluoroolefin-vinyl ether copolymer. In some embodiments, the base is dissolved in the aqueous solution. In an embodiment, mechanical stirring is employed to maintain a suspension, although other methods for forming and maintaining suspension should not be excluded. In an embodiment, the base is selected from NaHCO₃, Na₂CO₃, KHCO₃, K₂CO₃, or another common inorganic or organic base that would be suitable for this contacting step. A skilled artisan would generally be aware of suitable bases that can be employed in the contacting step.

In an embodiment, the suspension is heated to a temperature ranging from about 30° C. to about 100° C., from about 40° C. to about 75° C., or from about 45° C. to about 55° C. for a certain time period.

Fluorinated ionic polymer networks are formed in the form of spherical-like particles ranging in size from about 1 to about 10,000 microns, from about 10 to about 5,000 microns, from about 50 to about 2,500 microns, from about 100 to about 1,000 microns, from about 250 to about 750 microns, or from about 400 to 600 microns. In some embodiments, the size of the spherical-like particles are at least about 100 microns, about 250 microns, about 500 microns, about 750 microns, about 1000 microns, about 1500 microns, about 2000 microns, about 2500 microns, 3000 microns, 3500 microns, about 4000 microns, about 4500 microns, about 5000 microns, about 5500 microns, about 6000 microns, about 6500 microns, about 7000 microns, about 7500 microns, about 8000 microns, about 8500 microns, about 9000 microns, or at least about 9500 microns. In some embodiments, the size spherical-like particles are less than about 10,000 microns, about 9,000 microns, about 7000 microns, about 6000 microns, about 5000 microns, about 4000 microns, about 3000 microns, about 2000 microns, or less than about 1000 microns.

In some embodiments, the porosity of the spherical-like particles can vary and can be tuned by adding porogens to the above described preparative method. In some embodiments, the organic solvent is used as a porogen. In some embodiments, an additive is added as a porogen. In some embodiments, the porogen may be, but is not limited to, alkanes, fatty acids, long-chain alcohols (i.e., decanol, dodecanol, etc.) or any combination thereof.

In an embodiment, the organic solvent employed in the above method is an ether. In some embodiments, the organic solvent is ethyl 3-ethoxypropionate (eep), 2-methyl tetrahydrofuran (2-Me THF). In some embodiments, the organic solvent is a solvent with a high boiling point (i.e., a boiling point >100° C.) such as, but not limited to, toluene, xylene, or a combination thereof.

### D. Methods of Using the Fluorinated Ionic Polymer Networks

The fluorinated ionic polymer networks described herein are useful for removing polyfluorinated alkyl compounds from water by capturing the polyfluorinated alkyl compounds with the fluorinated ionic polymer networks. In an embodiment, the method further comprises the step of removing the fluorinated ionic polymer network comprising the captured polyfluorinated alkyl compound from the water. In some embodiments, the polyfluorinated alkyl compounds can be captured with the fluorinated ionic polymer networks by absorbing and/or adsorbing onto the fluorinated ionic polymer networks. In some embodiments, the polyfluorinated alkyl compounds can be captured with the fluorinated ionic polymer networks by being trapped with the fluorinated ionic polymer. In some embodiments, the polyfluorinated alkyl compounds can be removed with the fluorinated ionic polymer network in some other manner generally known in the art. In a further embodiment, the method comprises the step of separating the sorbed polyfluorinated alkyl compound from the fluorinated ionic polymer network.

In some embodiments, prior to performing the methods described herein, the water has a concentration of the perfluorinated alkyl compound from about 0.5 ng/L to about 5 mg/L, from about 0.5 ng/L to about 4 mg/L, from about 0.5 ng/L to about 3 mg/L, from about 0.5 mg/L to about 2 mg/L, from about 0.5 ng/L to about 1 mg/L, from about 0.5 ng/L to about 750 μg/L, from about 0.5 ng/L to about 500 μg/L, from about 0.5 ng/L to about 250 μg/L, from about 0.5 ng/L to about 100 μg/L, from about 0.5 ng/L to about 1 μg/L, or from about 0.5 ng/L to about 750 ng/L. In some embodiments, the water has a concentration of the perfluorinated alkyl compound from about 0.1 ng/L to about 500 μg/L, from about 0.1 ng/L to about 250 μg/L, from about 0.5 ng/L to about 100 μg/L, from about 0.5 ng/L to about 1 μg/L, from about 0.5 ng/L to about 750 ng/L, from about 1 ng/L to about 500 ng/L from about 10 ng/L to about 250 ng/L or from about 10 ng/L to about 100 ng/L. In some embodiments, the water has a concentration of the perfluorinated alkyl compound from about 1 μg/L to about 5 mg/L, from about 1 μg/L to about 3 mg/L, from about 1 μg/L to about 1 mg/L, from about 1 μg/L to about 0.5 mg/L, from about 1 μg/L to about 0.1 mg/L, from about 1 μg/L to about 750 μg/L, from about 1 μg/L to about 500 μg/L, from about 1 μg/L to about 250 μg/L, from about 1 μg/L to about 100 μg/L, from about 1 μg/L to about 50 μg/L, from about 1 μg/L to about 25 μg/L, from about 1 μg/L to about 10 μg/L, or from about 1 μg/L to about 5 μg/L. In some embodiments, the water has a concentration of the polyfluorinated alkyl compound of less than about 5 mg/L, about 4 mg/L, about 3 mg/L, about 2 mg/L, about 1 mg/L, about 0.5 mg/L, about 250 μg/L, about 100 μg/L, about 10 μg/L, about 1 μg/L, or about 750 ng/L.

In an embodiment, prior to performing the methods described herein, the water has a concentration of the polyfluorinated alkyl compound from about 0.1 ng/L to about 500 ng/L, 0.5 ng/L to about 500 ng/L, from about 1 ng/L to about 300 ng/L, from about 10 ng/L to about 250 ng/L, from about 15 ng/L to about 200 ng/L, from about 20 ng/L to about 150 ng/L, from about 25 ng/L to about 125 ng/L, from about 30 ng/L to about 100 ng/L, or from about 35 ng/L to about 70 ng/L. In some embodiments, the water has a concentration of the polyfluorinated alkyl compound from about 0.05 ng/L to about 200 ng/L, from about 0.05 ng/L to about 100 ng/L, from about 0.05 ng/L to about 50 ng/L, from about 0.05 ng/L to about 25 ng/L, from about 0.05 ng/L to about 20 ng/L, from about 0.05 ng/L to about 15 ng/L, from about 0.05 ng/L to about 10 ng/L, from about 0.05 ng/L to about 5 ng/L, or from about 0.05 ng/L to about 2 ng/L. In some embodiments, the water has a concentration of the polyfluorinated alkyl compound from about 1 ng/L to about 200 ng/L, from about 1 ng/L to about 150 ng/L, from about 1 ng/L to about 100 ng/L, from about 1 ng/L to about 80 ng/L, from about 1 ng/L to about 70 ng/L, from about 1 ng/L to about 50 ng/L, from about 1 ng/L to about 25 ng/L, or from about 1 ng/L to about 10 ng/L. In some embodiments, the water has a concentration of the polyfluorinated alkyl compound from about 1 ng/L to about 300 ng/L, from about 5 ng/L to about 250 ng/L, from about 10 ng/L to about 225 ng/L, from about 15 ng/L to about 200 ng/L, from about 20 ng/L to about 200 ng/L, from 25 ng/L to about 175 ng/L, from about 40 ng/L to about 150 ng/L, or from about 50 ng/L to about 125 ng/L. In some embodiments, the water has a concentration of the polyfluorinated alkyl compound ranging from about 20-200 ng/L as an upper limit to about 0.05-10 ng/L as a lower limit. In some embodiments, the water has a concentration of the polyfluorinated alkyl compound of less than about 500 ng/L, about 450 ng/L, about 400 ng/L, about 350 ng/L, about 300 ng/L, about 275 ng/L, about 250 ng/L, about 225 ng/L, about 200 ng/L, about 175 ng/L, about 150 ng/L, about 125 ng/L, about 100 ng/L, about 75 ng/L, about 50 ng/L, about 25 ng/L, about 10 ng/L or less than about 1 ng/L.

In an embodiment, the methods disclosed herein can be performed in any body of water. For example, the body of water can be a natural body of water, such as a lake, pond, stream, ocean, aquifer, or a manmade body of water, such as a treatment plant, pool, or dam. In one embodiment, the method is performed with nanopure water. In another embodiment, the method is performed with simulated natural water. In another embodiment, the method is performed with settled natural water. In another embodiment, the method is performed with well water. In another embodiment, the method is performed with industrial wastewater. In another embodiment, the method is performed with wastewater. In another embodiment, the method is performed with leachate water.

In an embodiment, the method disclosed herein comprises at least one fluorinated ionic polymer network disclosed herein. In some embodiments, the method disclosed herein comprises two or more fluorinated ionic polymer networks in the form of particles that are mixed together in a homogenous manner.

In an embodiment, the method disclosed herein can remove at least 60% of the polyfluorinated alkyl compound from the water. In other embodiments, the methods disclosed herein can remove at least about 65%, at least about 70%, at least about 75%, at least about 80%, at least about 85%, at least about 90%, at least about 95%, or at least about 99% of the polyfluorinated alkyl compound from the water. In some embodiments, the disclosed methods herein can remove about 60% to about 99.98%, from about 60% to about 99%, from about 65% to about 98%, from about 70% to about 98%, from about 75% to about 98%, from about 80% to about 98%, from about 85% to about 98%, from about 90% to about 98%, or from about 95% to about 98% of the polyfluorinated alkyl compound from the water.

In an embodiment, the polyfluorinated alkyl compound is dissolved in the water prior to performing the method.

In one aspect, the method further comprises the step of removing the fluorinated ionic polymer network comprising the absorbed polyfluorinated alkyl compound from the water. As such, the removed polyfluorinated alkyl compound is no longer present in the water, either as dissolved in the water or as absorbed in the fluorinated ionic polymer network. Removing the fluorinated ionic polymer network comprising the absorbed polyfluorinated alkyl compound can be done via filtration, where the fluorinated ionic polymer network comprising the absorbed polyfluorinated alkyl compound is filtered from the water. In another aspect, the fluorinated ionic polymer network is a filter or a part of a filter where water containing the polyfluorinated alkyl compound is filtered through the fluorinated ionic polymer network to remove the polyfluorinated alkyl compound.

In another aspect, the fluorinated ionic polymer network is in the form of particles and packed as a bed in a flow through column where water containing the polyfluorinated alkyl compound is filtered through the pack bed to remove the polyfluorinated alkyl compound. In such an embodiment, the bed volume of water containing the polyfluorinated alkyl compound to be filtered can vary. In some embodiments, the bed volume of water containing the polyfluorinated alkyl compound to be filtered is more than about 100, about 1,000, about 10,000, about 100,000, or more than 150,000 the bed volumes of the flow through column. In such an embodiment, minimal breakthrough of PFAS occurs. In some embodiments, less than about 50%, about 45%, about 40%, about 35%, about 30%, about 25%, about 20%, about 15%, about 10%, or about 5% breakthrough of PFAS occurs.

In one aspect, the method further comprises the step of separating the absorbed polyfluorinated alkyl compound from the fluorinated ionic polymer network. As such, the fluorinated ionic polymer network is regenerated and can be used again to absorb more polyfluorinated alkyl compound. In some embodiments, the fluorinated ionic polymer network is regenerated by contacting the network with an aqueous organic solution. In some embodiments, the aqueous organic solution contains dissolved salt or mixtures of salts. In some embodiments, the salts comprise inorganic salts, such as, but not limited to, an alkali metal salt. In some embodiments, the salt is sodium chloride. In some embodiments, the salt is a sulfate salt. In some embodiments, the salt is an organic salt, such as, but not limited, to ammonium acetate. In an embodiment, the aqueous organic solution contains at least about 1%, about 5%, about 10%, about 15%, about 20%, about 25%, about 30%, about 35%, about 40%, about 50%, about 55%, about 60%, about 65%, about 70%, about 75%, about 80%, about 85%, about 90%, or at least about 95% of an organic solvent. In some embodiments, the organic solvent is polar (e.g., alcohols such as methanol, ethanol, isopropanol, etc.). In some embodiments the organic solvent is not polar. In some embodiments, the fluorinated ionic polymer network is regenerated by contacting the network with an aqueous solution, which contains only water as a solvent.

In one aspect, the fluorinated ionic polymer network can be regenerated from 2 to 100 times, such as from 2 to 50 times, or from 2 to 25 times.

### E. Articles of Manufacture

In another aspect, described herein are articles of manufacture, for example, a “kit,” containing the one or more fluorinated ionic polymer network and a column or a filter. The kit comprises a container comprising the one or more fluorinated ionic polymer network. The column is designed to hold the one or more fluorinated ionic polymer networks. When a filter is used as part of a kit, the kit may further contain additional components that aid in the filtering of the one or more fluorinated ionic polymer network from the water being treated (e.g., a container to collect the filtered, purified water, etc.). In some embodiments, the kit may include additional filtering materials that can be used to filter the water. Such exemplary additional filtering materials include activated carbon (i.e., in a granular form) and/or one or more ion exchange resins. These additional filtering materials can be employed in filtering water either before or after contact with the fluorinated ionic polymer network, or they can be mixed within the fluorinated ionic polymer network. For kits that contain such additional filtering materials, the kit may further contain additional components that aid in the filtering of the water being treated (e.g., a container to collect the filtered, purified water, etc.). The kit advantageously can contain pre-measured amounts of the one or more fluorinated ionic polymer network (and additional filtering materials if applicable), for example, in amounts set forth elsewhere herein. The kit may further comprise a label or package insert, on or associated with the container. The term “package insert” is used to refer to instructions that can contain usage and warnings concerning the use of the components. Suitable containers for inclusion in the kit include, for example, bottles, vials, etc. The container may be formed from a variety of materials such as glass or plastic.

### E. EXAMPLES

The following preparations and examples are given to enable those skilled in the art to more clearly understand and to practice the present invention. They should not be considered as limiting the scope of the invention, but merely as being illustrative and representative.

In one aspect, disclosed are methods of making the fluoroolefin-vinyl ether copolymers and the fluorinated ionic polymer networks. In another aspect are disclosed methods of using the fluorinated ionic polymer networks in removal of PFAS from water.

### Example 1—Fluorinated Ionic Polymer Network Synthesis

The fluorinated ionic polymer networks comprise FVE copolymers that are chemically crosslinked into polymer networks through a nucleophilic displacement reaction with a reactive vinyl ether monomer. See Scheme 4 below for an example of this synthesis.

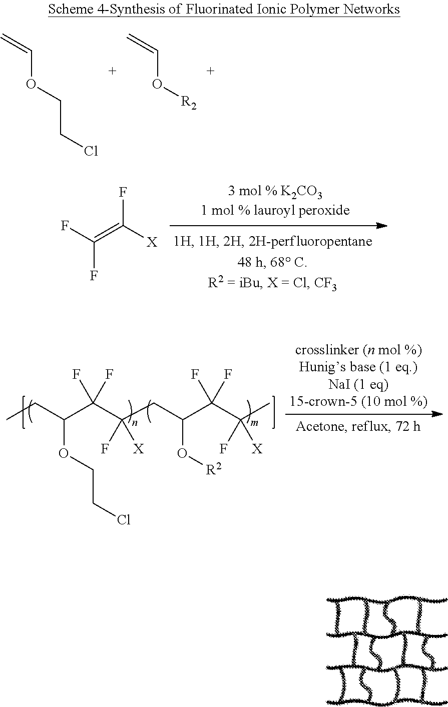

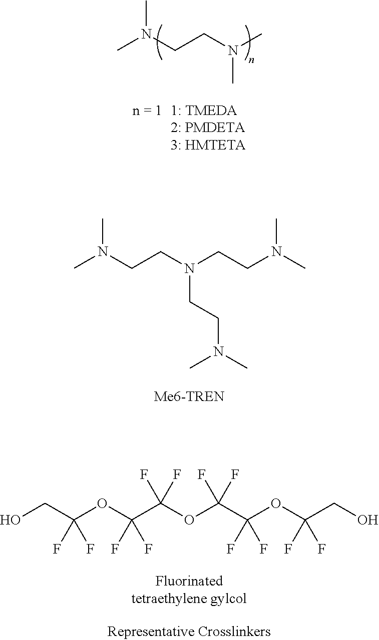

CEVE: chloroethyl vinyl ether; TMEDA: N,N,N′,N′ -tetramethylethylenediamine; PMDETA: N,N,N′,N″,N″ -pentamethyldiethylenetriamine; HMTETA: 1,1,4,7,10,10-hexamethyltriethylenetetramine; Me6-TREN: tris [2-(dimethylamino)ethyl]amine; fluorinated tetraethylene glycol: 1H,1H,11H,11H-perfluoro-3,6,9-trioxaundecane-1,11-diol.

It is to be understood that in the fluoroolefin-vinyl ether copolymer depicted above in Scheme 4, the copolymer is not limited to just the pictured alternating repeat units. The copolymer may comprise alternating repeat units, repeating repeat units, or any combination of repeat units.

These synthetic methods allow the tuning the fluorophilicity of fluorinated ionic polymer networks by varying the fluoroolefin (such as with tetrafluoroethylene, chlorotrifluoroethylene, hexafluoropropylene) and the vinyl ether (such as with ethyl, n-butyl, i-butyl) co-monomers that comprise the FVEs. Table 1 represents a small sampling of the FVE polymers, including the ability to vary the identity of the fluoroolefin and the vinyl ether.

TABLE 1
Selected FVEs

| Entry | mol % CEVE | R′ | mol % VE | X | mol % Fluoroolefin | % yield | M_{n kg/mol)} | Ð |
|---|---|---|---|---|---|---|---|---|
| FVE-1 | 50 | — | 0 | CF₃ | 50 | 47 | 10.1 | 1.38 |
| FVE-2 | 50 | — | 0 | C1 | 50 | 90 | 19.8 | 1.91 |
| FVE-3 | 25 | iBu | 25 | CF₃ | 50 | 38 | 14.5 | 1.35 |

### Example 2—Selected Fluorinated Ionic Polymer Networks

Incorporation of functional vinyl ether co-monomers such as chloroethyl vinyl ether (CEVE) provides a handle for post-polymerization crosslinking. Displacement of the electrophilic chlorine functionality with multifunctional (2 or greater) nucleophiles crosslinks the FVEs into fluorinated ionic polymer networks. When these multifunctional nucleophiles include tertiary amines, a quaternary ammonium is formed that provides a permanent charge within the network. Using a series of multifunctional amines, a systematic set of fluorinated ionic polymer networks was produced with varied fluorophilic and electrostatic components.

The new class of FVE fluorinated ionic polymer networks was synthesized via a variety of crosslinking reactions with diamines and diols (including perfluoropolyether oligomers to enhance fluorine density) (Scheme 5). The resulting resins were ground, purified via Soxhlet extraction in ethanol, and dried in vacuo to yield a granular formulation. Size sieves can be used to isolate particles of different sizes (such as a targeted range of 75-125 μm in size).

Alternatively, the fluorinated ionic polymer network can be made under suspension or emulsion conditions. Briefly, the FVE polymer and crosslinking agent are dissolved in a minimal amount of organic solvent (such as 2-methyl tetrahydrofuran) and water or a salt solution (pH>7) can be added. Rapid stirring creates suspended droplets of an organic phase that contains the FVE polymer and crosslinking agent. Stabilizers, surfactants, and/or other common additives can be used to stabilize the biphasic mixture. Stirring the reaction and (optionally) heating the mixture results in crosslinking with each droplet and yields spherical fluorinated ionic polymer network particles whose size and dispersity can be tuned based on the conditions in which the suspension/emulsion was generated. An exemplary procedure for this preparative method is provided in Examples 15 and 16.

Particle size can be precisely controlled by controlling monomer droplet (d) size via stirring speed (N), stabilizer concentration (Cₛ), reactor diameter (Dᵥ), stirrer size (Dₛ), viscosity (v_{d}), and volume ratio of droplet phase to suspension medium (vₘ) (Equation 1).⁵²

$$\overline{d} = k \frac{{D}_{v} \cdot R \cdot {v}_{d} \cdot ε}{{D}_{s} \cdot N \cdot {v}_{m} \cdot {C}_{s}} . \qquad Equation 1$$

TABLE 2
Selected Fluorinated Ionic Polymer Networks

| Resin | FVE | mol % TMEDA | mol % PFPE |
|---|---|---|---|
| IF-1 | 1 | 10 | 0 |
| IF-2 | 1 | 40 | 0 |
| IF-3 | 1 | 60 | 0 |
| IF-4 | 1 | 10 | 20 |
| IF-5 | 2 | 20 | 0 |
| IF-6 | 2 | 40 | 0 |
| IF-7 | 2 | 60 | 0 |

### Example 3—Comparator Systems

Poly(hexafluoropropene-co-chloroethyl vinyl ether) (HFP-co-CEVE) poly(chlorotrifluoroethylene-co-chloroethyl vinyl ether) (CTFE-co-CEVE), and poly(hexafluoropropene-co-chloroethyl vinyl ether-co-isobutyl vinyl ether) (HFP-co-CEVE-co-iBVE) were synthesized according to literature precedent.³²

Attempts to prepare fluorinated ionic polymer networks using Halar copolymers (such as poly(ethylene-co-chlorotrifluoroethylene) which is also known as ECTFE or poly(1-chloro-1,2,2-trifluorobutane-1,4-diyl)) via the methods described herein were not successful.

### Example 4—Synthesis of FVE Copolymer, CTFE-co-CEVE (FVE-2)

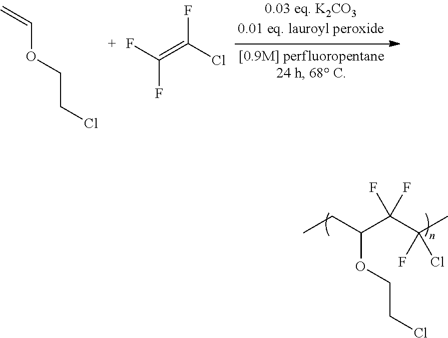

Poly(chlorotrifluoroethylene-co-chloroethyl vinyl ether) (i.e., CTFE-co-CEVE) was synthesized according to an altered literature procedure.⁵³ A 40 mL Parr reactor was charged with lauroyl peroxide (0.01 eq., 37 mg) and potassium carbonate (0.03 eq, 39 mg). The reactor was not sealed and was kept under positive flow of N₂ gas. Chloroethyl vinyl ether (1.0 eq, 0.95 mL) was combined with 4 mL perfluoropentane and sparged under nitrogen. The mixture was then added via syringe to the Parr reactor. The reactor was cooled to −78° C. A 13 mL glass graduated centrifuge tube was filled with N₂ gas, sealed with a rubber septum, and cooled to −78° C. To the centrifuge tube was added 4 mL of perfluoropentane. Chlorotrifluoroethylene (1.4 eq, 1 mL at −78° C.) was distilled into the graduated centrifuge tube. The mixture was transferred via cannula to the cooled Parr reactor. The reactor was sealed, allowed to warm to room temperature, then stirred and heated to 68° C. for 24 hours. After completion of the reaction, the Parr reactor was cooled to room temperature and vented. The crude mixture was concentrated via rotary evaporation, then dissolved in the minimum amount of acetone. The pure product was achieved via precipitation into cold methanol with one drop of brine, followed by filtration and drying in vacuo. The product was a white powder (1.89 g, 90% yield).

### Example 5—Synthesis of Ionic Fluorogel (IF-6)

Poly(chlorotrifluoroethylene-co-chloroethyl vinyl ether) (1 eq., 200 mg) was dissolved in acetone (0.3M), and added to an 8 mL glass vial containing tetramethylethylenediamine (0.4 eq., 37 mg), sodium iodide (1 eq., 118 mg), Hunig's base (1 eq., 102 mg), and 15-crown-5 (0.1 eq, 17 mg). The reaction mixture was sparged under N₂ for 10 minutes, then sealed with the vial cap and electrical tape. The mixture was then heated to 56° C. over 72 hours with no stirring. After an insoluble gel was formed, the crude product was removed from heat, ground into multiple pieces, and purified via Soxhlet extraction with ethanol. IF-6 was then dried in a vacuum oven at 50° C. to yield the pure product as a brown powder.

### Example 6—Bulk Synthesis of Ionic Fluorogel IF-6

Poly(chlorotrifluoroethylene-co-chloroethyl vinyl ether) (1 eq., 200 mg) was dissolved in acetone (0.3M), and added to and 8 mL glass vial containing tetramethylethylenediamine (0.4 eq., 37 mg), sodium iodide (1 eq., 118 mg), Hunig's base (1 eq., 102 mg), and 15-crown-5 (0.1 eq, 17 mg). The reaction mixture was sparged under N₂ for 10 minutes, then sealed with the vial cap and electrical tape. The mixture was then heated to 56° C. over 72 hours with no stirring. After an insoluble gel was formed, the crude product was removed from heat, ground into multiple pieces, and purified via Soxhlet extraction with ethanol. IF-6 was then dried in a vacuum oven at 50° C. to yield the pure product as a brown powder.

### Example 7—Removal Rates and EC Measurements of Ionic Fluorogels IF-1 to IF-7

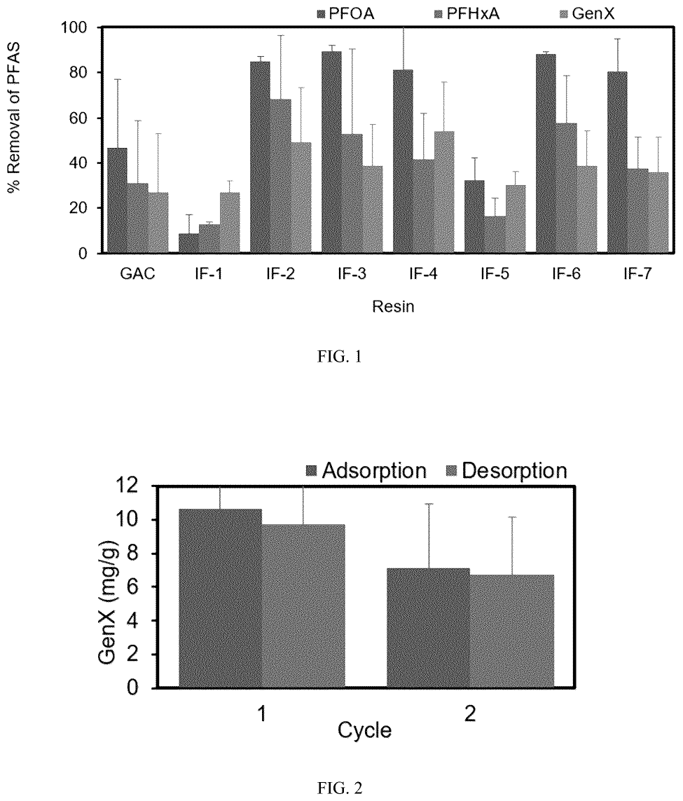

The PFAS removal efficiency of the fluorinated ionic polymer network from simulated natural water was achieved via batch equilibrium adsorption tests,^{31,50} wherein deionized water was spiked with 200 mg/L NaCl and 20 mg/L humic acid. 10 mg/L fluorinated ionic polymer network was added to the water and stirred for 3 hours in order to hydrate the resin. Then, the solution was spiked with environmentally relevant (1 μg/L) concentrations of each PFOA, perfluorohexanoic acid (PFHxA), and GenX. After 21 hours, an aliquot of water was taken, centrifuged, and then submitted for analysis via Liquid Chromatography-Mass Spectrometry (LC-MS). Performance of the fluorinated ionic polymer networks was gauged by percent removal of PFAS (FIG. 1). Fluorinated ionic polymer networks containing 40-60 mol % TMEDA outperformed commercial GAC (Filtrasorb 400). Fluorinated ionic polymer networks with higher fluorine density, either via the incorporation of hexafluoropropylene as the fluoroolefin or via incorporation of PFPE crosslinking agent, outperformed those resins with lower fluorine density. Notably, 80% of PFOA was removed in all cases where at least 40 mol % amine was incorporated.⁵¹ However, short-chain PFAS PFHxA and GenX were better removed when the fluorine density was increased.

It is worth noting that the batch equilibrium adsorption conditions described above are extremely stringent (meant to simulate high organic and ion content surface waters); a 20,000 times excess by mass of humic acid and 200,000 excess by mass of NaCl relative to each PFAS was targeted to probe selectivity and efficiency of the FVE-IF. Investigating GenX removal by IF-2 at varied concentrations (1 ug/L to 50 mg/L) in both nanopure water and simulated natural water as described above demonstrates the robustness of the FVE-IF (FIG. 9, Table 3). In pure water, GenX adsorption is more efficient. When [GenX]₀ is on the same order as [humic acid] (1 mg/L, 10 mg/L), GenX adsorption by IF-2 is efficient in simulated natural water. These data indicate a matrix-dependence regarding PFAS adsorption by the IF.

TABLE 3
Removal of GenX at varied concentrations (mg/L)
in nanopure and simulated natural water.

| | |
|---|---|
| [GenX]₀ | % Removal of GenX |

| (mg/L) | Nanopure water | Simulated natural water |
|---|---|---|
| 0.001 | 98 | 48 |
| 1 | 95 | 90 |
| 10 | 90 | 85 |
| 50 | 69 | 49 |

### Example 8—Regeneration Experiments of IF-2

One material (IF-2) was subjected to regeneration experiments in flow through experiments (FIG. 2). These tests demonstrated regeneration and also demonstrated the ability of these materials to be used in a pack-bed resin geometry. 20 mg IF-2 was suspended in 5 mL water and sonicated 5 minutes. Then, the suspension was pushed into a 0.45 um PTFE syringe filter (22 mm). 20 mL of 10 mg/L GenX solution was then flowed through the syringe filter over 2 minutes, and the effluent was collected for LC-MS analysis. Next, 20 mL 400 mM ammonium acetate solution in methanol was flowed through the syringe over 2 minutes to remove the GenX and regenerate the resin. Again, the effluent was collected for LCMS. The process was repeated once more. This successful experiment demonstrated adsorption and subsequent full desorption of GenX over two cycles. This shows the fluorinated ionic polymer networks disclosed herein are useful PFAS remediation resins that can be regenerated, where they can be washed to remove adsorbed PFAS and reused to avoid breakthrough and leaching of PFAS at significant bed volumes.

### Example 9—Hydrolytic Stability

Previously prepared fluorinated ionic polymer networks, based on Fluorolink perfluoropolyethers, would be unstable under basic conditions due to carbamate linkages inherent to Fluorolink MD700 (pictured below). In contrast, the FVE-based fluorinated ionic polymer networks disclosed herein demonstrate hydrolytic stability and are operationally more direct to synthesize. In support of this, stability experiments were performed. Specifically, 10 mg/mL each of the fluorinated ionic polymer networks IF-2 and Fluorolink-IF-1 were suspended in 0.1M KOH solution and stirred at 80° C. for 24 hours, after which the solutions were filtered. While IF-2 was recovered, albeit in 30% yield, Fluorolink-IF-1 was completely dissolved. This experiment indicates that this new class of FVE-based fluorinated ionic polymer networks represented by IF-2 are more stable in basic solutions than Fluorolink-based materials.

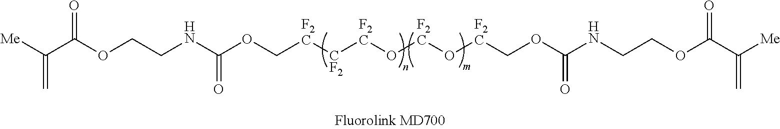

The FVE-based fluorinated ionic polymer networks disclose herein demonstrate success at removing a range of PFAS from simulated natural water, and they also demonstrated facile regeneration. The synergistic combination of fluorophilicity and ion exchange components is effective in removing PFAS from water.

### Example 10—Fluorinated Ionic Polymer Networks Synthesis from Commercially Available FVE Copolymers

The fluorinated ionic polymer networks can comprise commercially available FVE copolymers that are chemically crosslinked into polymer networks through a nucleophilic displacement reaction with a reactive vinyl ether monomer. Additional modification with a post-crosslinking agent of the fluorinated ionic polymer networks provides the opportunity to control the charge density and the three-dimensional structure of the network. See Scheme 5 below for an example of this synthesis.

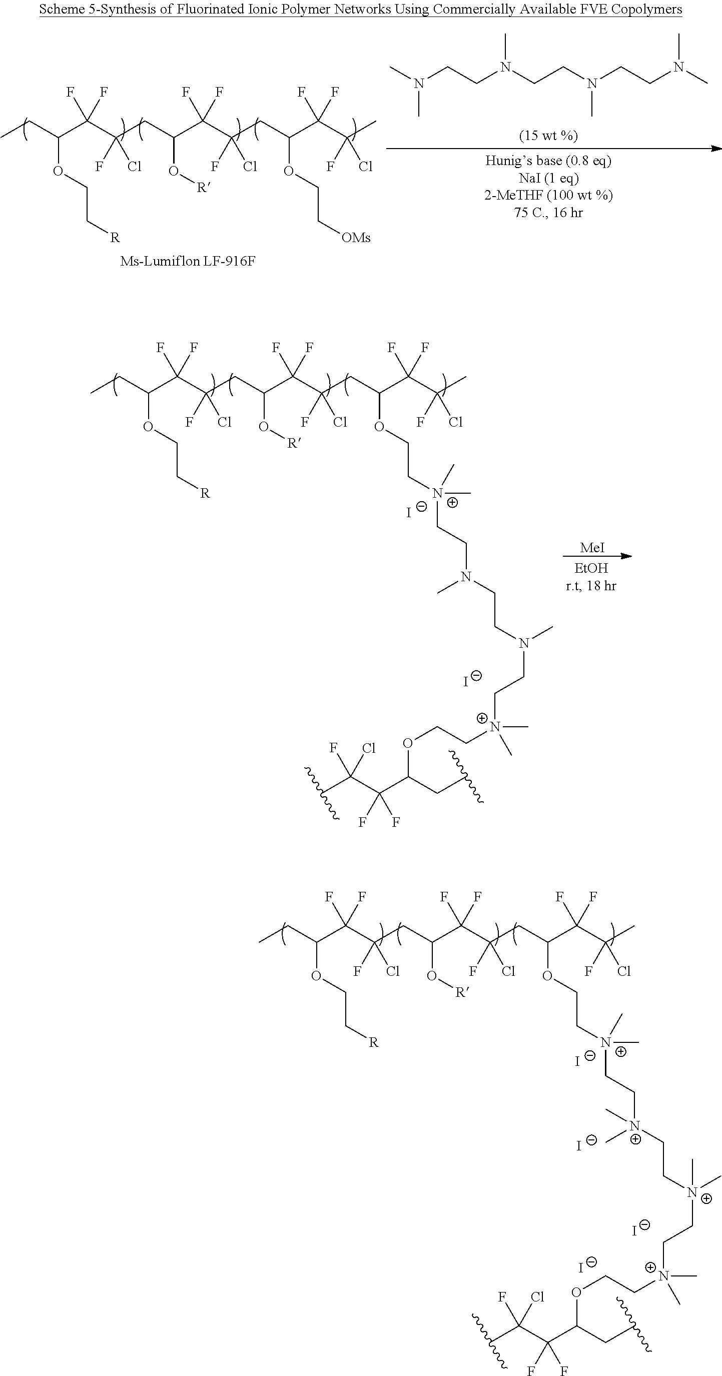

Instead of preparing FVE copolymers as described above in Scheme 4, FVE copolymers can be purchased directly from commercial sources.^{52,53} For example, commercially available FVE copolymers from Asahi Glass Company, which are sold under the brand name of LUMIFLON® can be crosslinked via the pendant hydroxyl groups via multifunctional nucleophiles in the same manner as already described above in Example 1 to yield ionic fluorogels (IFs). To increase the rate and efficiency of crosslinking, the hydroxy groups were first converted to mesylates. Then, crosslinking via multiamines affords the desired ionic fluorogels. An exemplary preparation of such an IF is shown in Scheme 5, where commercially available FVE copolymers LF916F having a varied composition of functional commoner hydroxyethyl vinyl ether were mesylated to afford Ms-Lumiflon LF-916F in Scheme 5, which was subsequently crosslinked with TMEDA. Conversion of the hydroxyl groups to mesylates provided an increase in the rate and efficiency of the crosslinking reaction. Then, crosslinking via multiamines yielded ionic fluorogels. This chemistry can also be applied to other commercially available FVEs, such as LF9721, for example.

It should be noted that the resulting IFs can be further modulated with post-crosslinking additives to vary the charge density as well as the three-dimensional structure of the IFs thereby changing the properties of the IFs, as is also illustrated in Scheme 5. Exemplary crosslinkers and post-crosslinking additives are shown below, but should not be limited thereto.

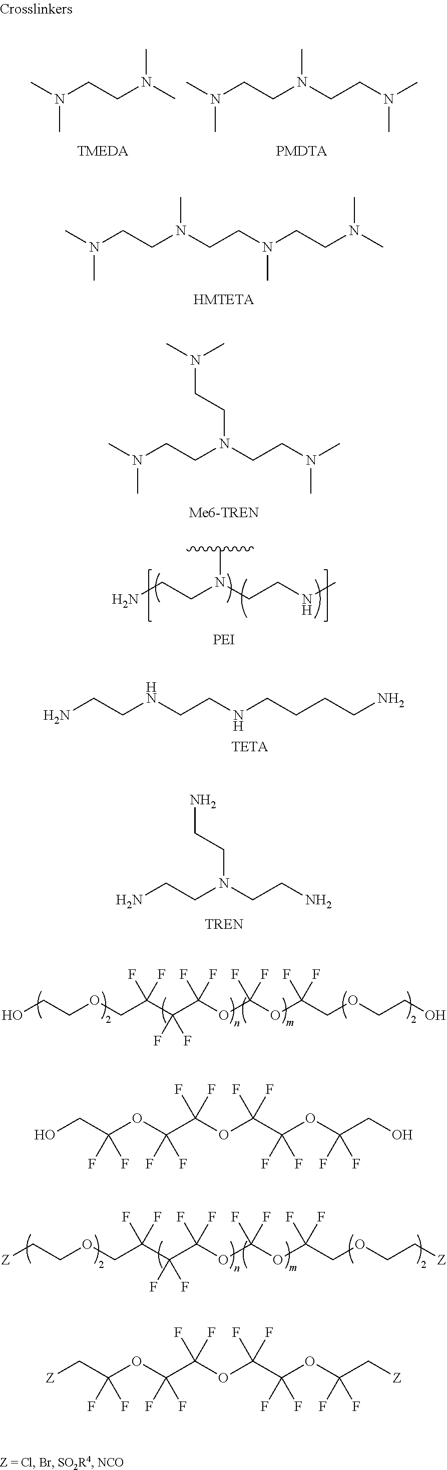

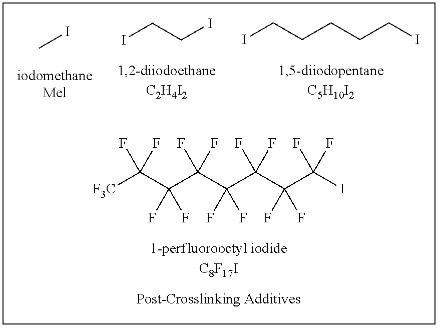

TMEDA: N,N,N′,N′-tetramethylethylenediamine; PMDETA: N,N,N′,N″,N″-pentamethyl diethylenetriamine; HMTETA: 1,1,4,7,10,10-hexamethyltriethylenetetramine; Me6-TREN: tris[2-(dimethylamino)ethyl]amine; fluorinated tetraethylene glycol: 1H,1H,11H,11H-perfluoro-3,6,9-trioxaundecane-1,11-diol; PEI: polyethyleneimine; TETA: triethylenetetramine; TREN: tris(2-aminoethyl)amine.

In addition, it is to be understood that Scheme 5 represent an example of that such chemical transformation can generally be employed for other commercially available FVE copolymers.

Table 4 below represents exemplary IFs synthesized from commercial FVE copolymers. It should be noted that these IF s were named according to the notation IF-(multiamine)-(weight % multiamine). For example, an IF crosslinked with 10 wt % tetramethylethylenediamine (TMEDA) is named IF-TMEDA-10. Some IF were stirred with iodomethane to fully quaternize any unreacted amines. Those are denoted “q” (i.e., IF-TMEDA-10q). Other IF were stirred with alternative alkyl iodides to install additional fluorine density (1H, 1H, 2H, 2H-perfluorooctyl iodide) or crosslinks (1,2-diiodoethane). These IF are denoted “qf” or “qd” respectively. Some IF were prepared using a mixture of multiamine crosslinkers (i.e. Me6TREN and TMEDA).

TABLE 4
Selected IF Synthesized from Commercial FVE Copolymer

| | | | Fully | |
|---|---|---|---|---|
| Reference | Crosslinker | wt % | Quaternized? | Additive |
| IF-TMEDA-7 | TMEDA | 7 | no | N/A |
| IF-PMDTA-11 | PMDTA | 11 | no | N/A |
| IF-PMDTA-16 | PMDTA | 16 | no | N/A |
| IF-PMDTA-20 | PMDTA | 20 | no | N/A |
| IF-PMDTA-30 | PMDTA | 30 | no | N/A |
| IF-PMDTA-30q | PMDTA | 30 | yes | MeI |
| IF-PMDTA-40 | PMDTA | 40 | no | N/A |
| IF-PMDTA-40q | PMDTA | 40 | yes | MeI |
| IF-HMTETA-15 | HMTETA | 15 | no | N/A |
| IF-HMTETA-20 | HMTETA | 20 | no | N/A |
| IF-HMTETA-20q | HMTETA | 20 | yes | MeI |
| IF-HMTETA-30 | HMTETA | 30 | no | N/A |
| IF-HMTETA-30q | HMTETA | 30 | yes | MeI |
| IF-HMTETA-30qf | HMTETA | 30 | yes | C₈F₁₇I |
| IF-HMTETA-40 | HMTETA | 40 | no | N/A |
| IF-HMTETA-40q | HMTETA | 40 | yes | MeI |
| IF-HMTETA-40qd | HMTETA | 40 | yes | C₂H₄I₂ |
| IF-Me6TREN-20 | Me6TREN | 20 | no | N/A |
| IF-Me6TREN-20q | Me6TREN | 20 | yes | MeI |
| IF-Me6TREN-20qd | Me6TREN | 20 | yes | C₂H₄I₂ |
| IF-Me6TREN-40 | Me6TREN | 40 | no | N/A |
| IF-Me6TREN-40q | Me6TREN | 40 | no | MeI |
| IF-TETA-14q | TETA | 14 | yes | MeI |
| IF-TETA-20q | TETA | 20 | yes | MeI |
| IF-TETA-30q | TETA | 30 | yes | MeI |
| IF-TREN-14q | TREN | 14 | yes | MeI |
| IF-TREN-20q | TREN | 20 | yes | MeI |
| IF-PEI-9 | PEI | 9 | no | N/A |
| IF-PEI-9q | PEI | 9 | yes | MeI |
| IF-PEI-20 | PEI | 20 | no | N/A |
| IF-PEI-30 | PEI | 30 | no | N/A |
| IF-PEI-30q | PEI | 30 | yes | MeI |
| IF-PEI-40 | PEI | 40 | no | N/A |

In addition, IFs were also prepared using multiple crosslinkers as shown in Table 5 below.

TABLE 5
Selected IF with LF9721 as the FVE Copolymer

| Reference | Crosslinker | wt % |
|---|---|---|
| IF-LF9721-TMEDA-10 | TMEDA | 10 |
| IF-LF9721-TMEDA-20 | TMEDA | 20 |
| IF-LF9721-Me6TREN-20 | Me6TREN | 20 |
| IF-LF9721-Me6TREN-30 | Me6TREN | 30 |

TABLE 6
Selected IF Synthesized with Multiple Crosslinkers

| Reference | Crosslinker 1 | wt % | Crosslinker 2 | wt % |
|---|---|---|---|---|
| IF-M6-TMEDA-1 | Me6TREN | 15 | TMEDA | 5 |
| IF-M6-TMEDA-2 | Me6TREN | 15 | TMEDA | 10 |
| IF-M6-TMEDA-3 | Me6TREN | 10 | TMEDA | 10 |
| IF-M6-PMDTA-1 | Me6TREN | 15 | PMDTA | 5 |
| IF-M6-PMDTA-2 | Me6TREN | 15 | PMDTA | 10 |
| IF-M6-HMTETA-1 | Me6TREN | 15 | HMTETA | 5 |
| IF-M6-HMTETA-2 | Me6TREN | 15 | HMTETA | 10 |
| IF-M6-HMTETA-3 | Me6TREN | 10 | HMTETA | 10 |
| IF-Me6TREN-20- | Me6TREN | 20 | Mesylated | 10 |
| E10H-10 | | | Fluorolink E10H | |
| IF-Me6TREN-20- | Me6TREN | 20 | Mesylated | 20 |
| E10H-20 | | | Fluorolink E10H | |
| IF-LF9721-TMEDA- | TMEDA | 20 | Mesylated | 10 |
| 20-E10H-10 | | | Fluorolink E10H | |
| IF-LF9721-TMEDA- | TMEDA | 20 | Mesylated | 20 |
| 20-E10H-20 | | | Fluorolink E10H | |

### Example 11—Mesylation of Commercial FVE Copolymer (Ms-FVE)

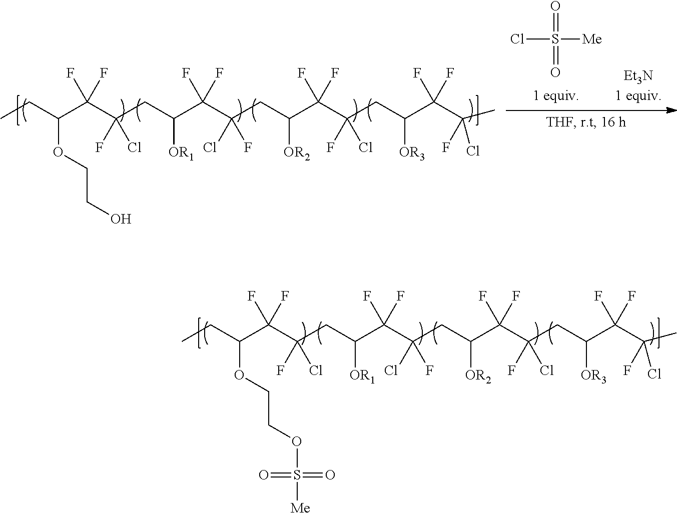

Commercial FVE copolymer (10.0g, 1.8mmol OH/g polymer) was dissolved in THF (100. g) in a nitrogen-purged round-bottom flask equipped with stir bar. The reaction mixture was sparged and cooled to 0° C. Methanesulfonyl chloride (1.41 mL, 18.0 mmol, 1.0 equiv. relative to —OH) was added dropwise. Then, triethylamine (2.52 mL, 18.0 mmol, 1.0 equiv. relative to —OH) was added dropwise. The reaction was slowly warmed to room temperature and stirred 16 hours. Insoluble salts were filtered through fritted glass, and solvent was removed under reduced pressure. The resulting oil was precipitated into cold methanol. After precipitation, the solvent was decanted, and the polymer was dried in vacuo to yield the pure product as a white glassy powder (10.5 g, 94% yield).

### Example 12—Removal Rates and EC Measurements of IFs Prepared in Example 10

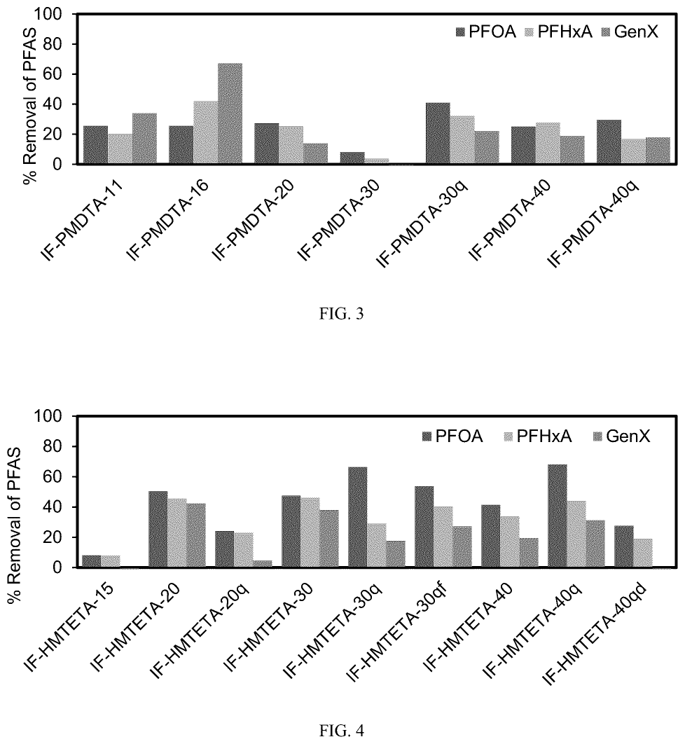

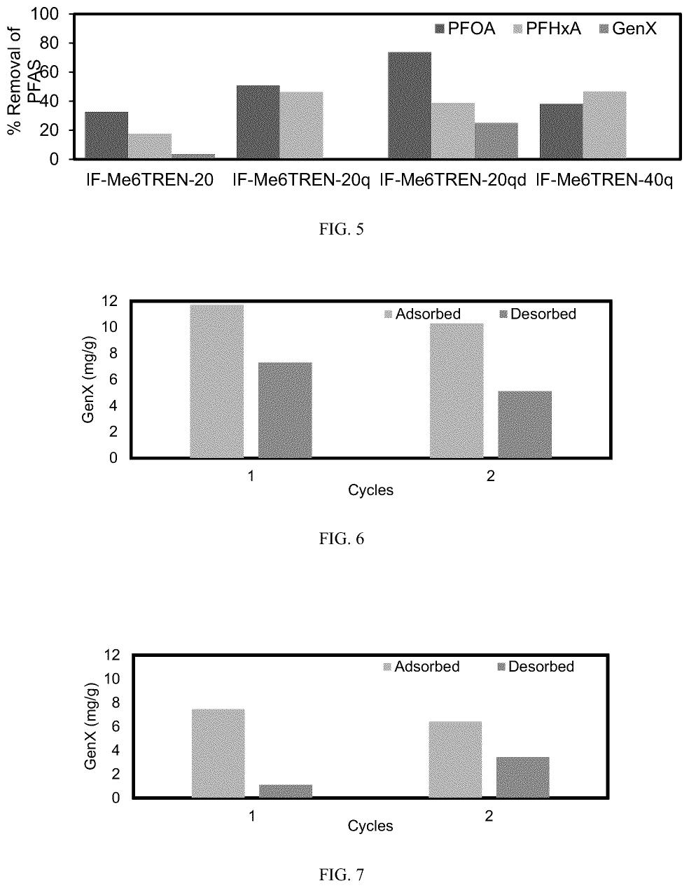

The PFAS removal rate efficiency of the PVE copolymers prepared in Tables 4-6 of Example 10 was determined using the same experimental procedure as outlined in Example 6. The results are shown in FIGS. 3-5, which show the performance of the PVE polymers as a percentage of PFAS (i.e., PFOA, PFHxA and Gen X). Removal rates generally range from about 1% to about 80%. Also see Tables 7-9 below.

TABLE 7
% Removal of PFAS

| | % Removal of PFAS | | |
|---|---|---|---|
| Ionic Fluorogel | PFOA | PFHxA | GenX |
| IF-PMDTA-11 | 26 | 20 | 34 |
| IF-PMDTA-16 | 26 | 42 | 67 |
| IF-PMDTA-20 | 27 | 26 | 14 |
| IF-PMDTA-30 | 8 | 4 | −10 |
| IF-PMDTA-30q | 41 | 32 | 22 |
| IF-PMDTA-40 | 25 | 28 | 19 |
| IF-PMDTA-40q | 29 | 17 | 18 |

TABLE 8
% removal of PFAS

| | % Removal of PFAS | | |
|---|---|---|---|
| Ionic Fluorogel | PFOA | PFHxA | GenX |
| IF-HMTETA-15 | 8 | 8 | −3 |
| IF-HMTETA-20 | 50 | 46 | 42 |
| IF-HMTETA-20q | 24 | 23 | 5 |
| IF-HMTETA-30 | 48 | 46 | 38 |
| IF-HMTETA-30q | 66 | 29 | 18 |
| IF-HMTETA-30qf | 54 | 41 | 27 |
| IF-HMTETA-40 | 41 | 34 | 20 |
| IF-HMTETA-40q | 68 | 44 | 31 |
| IF-HMTETA-40qd | 28 | 19 | −3 |

TABLE 9
% Removal of PFAS

| | % Removal of PFAS | | |
|---|---|---|---|
| Ionic Fluorogel | PFOA | PFHxA | GenX |
| IF-Me6TREN-20 | 33 | 18 | 4 |
| IF-Me6TREN-20q | 51 | 46 | N/A* |
| IF-Me6TREN-20qd | 74 | 39 | 25 |

*not analyzed

The results above show that the PFAS removal can, in part, be modulated with the degree of positive charge present in the network. IFs with a higher degree of permanent positive charge (either through complete crosslinking of multiamine(s) or full quarternization by an additive) can demonstrate improved PFAS removal. With respect to the choice of the multiamine, Me6TREN provides a good performance with LF916F as the fluoropolymer. However, using FVEs with high functional comonomer incorporation (either those synthesized or commercially available LF9721), TMEDA provides highly efficient performance. Not be bound by theory, it is believed that this is observed because of the high maximum crosslink density, which translates to higher incorporation of permanent cationic character.

### Example 13—Regeneration Experiments of IF-HMTETA-40q

One material (IF-HMTETA-40q) was subjected to regeneration experiments in flow through experiments using either an organic solution (i.e., 50% aqueous ethanol with 400 mM ammonium acetate; FIG. 6) or an aqueous solution (i.e., aqueous sodium chloride; FIG. 7) as eluent. These tests demonstrated regeneration and also demonstrated the ability of these materials to be used in a pack-bed resin geometry. The experimental conditions are the same as described above in Example 12. The results of this experiment further demonstrated adsorption and subsequent full desorption of GenX over two cycles with either eluent. As already mentioned above, this is another example that shows that the fluorinated ionic polymer networks disclosed herein are useful PFAS remediation resins that can be regenerated, where they can be washed to remove adsorbed PFAS and reused to avoid breakthrough and leaching of PFAS at significant bed volumes.

### Example 14—Mini-Rapid Small Scale Column Test of IF-Me6TREN-20

Packing IF into a flow-through column geometry enables translationally relevant analysis of performance. Studies have shown that sorbent pore structure, surface chemistry, and nature of binding sites plays a role in PFAS removal efficacy by granular sorbents.⁵⁴⁻⁵⁹ IF can be evaluated for their removal of PFOA, PFHxA, and GenX from surface drinking water using mini rapid small scale column tests (mini-RS SCTs). Mini-RS SCT data is used both to compare packed-bed performance relative to commercial materials,^{54,58} and to estimate full-scale performance (i.e., predict breakthrough curves of full-scale columns).⁶⁰⁻⁶³ Thus, a wide variety of IFs, including IF-Me6TREN-20, was tested for its ability to remove PFAS efficiently from water when packed in a column.

The baseline mini-RSSCT testing conditions were as follows: 0.318 cm column inner diameter, 68.5 μm mean grain diameter, 26.3 m/h hydraulic loading rate (HLR), 1.9 s empty bed contact time (EBCT), 1.4 cm media depth, 3.5 mL/min flow rate, 500 ng/L for each PFAS, pH 7.0, 3.2 days (up to 300,000 bed volumes) run time.

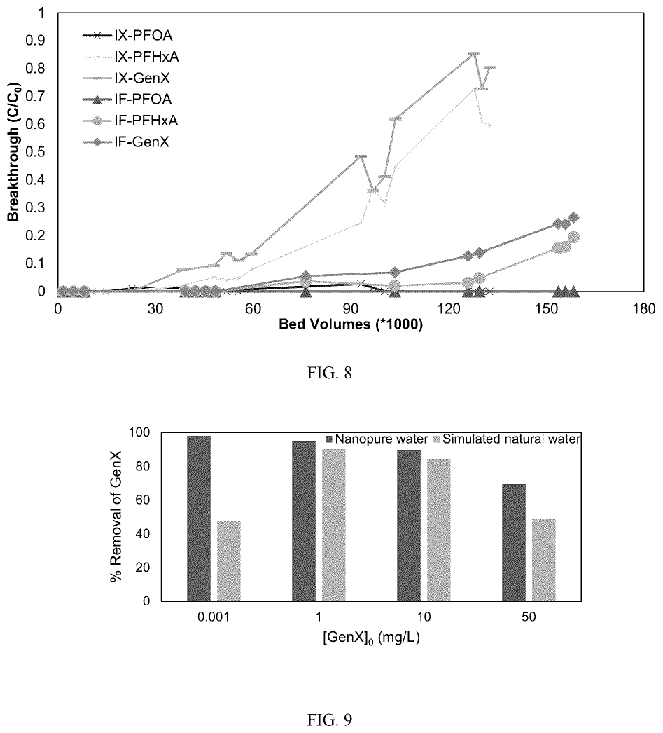

Breakthrough was determined at point BV10, where the concentration of PFAS in the effluent (C) relative to the influent (CO) equals 10%. It was observed that Purolite 694AE, a ion exchange resin for PFAS, had a BV10 of ˜50,000 bed volumes for GenX and ˜60,000-90,000 BW for PFHxA. By contrast, IF-Me6TREN-20 demonstrated BV10=−126,000 for GenX and ˜154,000 for PFHxA. Therefore, IF-Me6TREN-20 outperforms Purolite under these conditions (see FIG. 8).

### Example 15—Heterogeneous IF Synthesis via Suspension Crosslinking

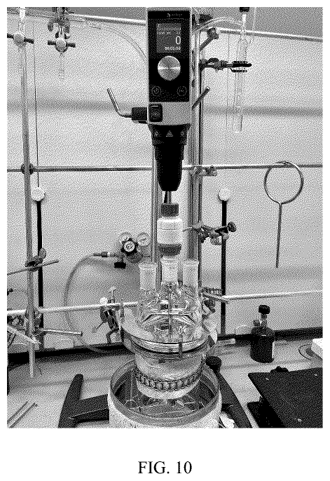

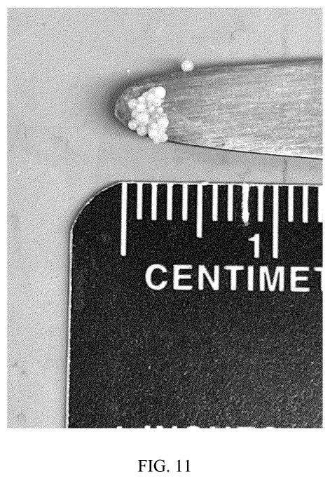

Commercial ion exchange resins are typically synthesized via heterogeneous suspension or emulsion processes using an aqueous continuous phase and an immiscible organic phase containing monomer and crosslinker. Disclosed herein is an analogous crosslinking method to synthesize IF through a heterogeneous process. The reactor design is shown in FIG. 10. For example, uniform beads of IF-Me6TREN-20 were achieved after stirring both phases at 225 rpm over 19 total hours at varied temperature. The beads were uniform between 100-1000 microns (FIG. 11).

### Controlling Particle Size Via Suspension Polymerization:

Particle size can be precisely controlled by controlling monomer droplet (d̅) size via stirring speed (N), stabilizer concentration (Cₛ), reactor diameter (Dᵥ), stirrer size (Dₛ), viscosity (v_{d}), and volume ratio of droplet phase to suspension medium (vₘ) (Equation 1).⁶⁴

$$\overline{d} = k \frac{{D}_{v} \cdot R \cdot {v}_{d} \cdot ε}{{D}_{s} \cdot N \cdot {v}_{m} \cdot {C}_{s}} . \qquad Equation 1$$

### Example 16—Synthesis of IF-Me6TREN-20 via Suspension Crosslinking

In a round-bottom flask equipped with stir bar, 8.0 g Ms-FVE was dissolved in 10.0 g ethoxy-3-ethylpropanoate and 10.0 g 2-methyltetrahydrofuran. After dissolution of the polymer, 2.0g tris[2-(dimethylamino)ethyl]amine (Me6TREN) was added. In a 1L suspension reactor under nitrogen, 2.30 g sodium bicarbonate, 0.92 g poly(vinyl alcohol) (xxx) were dissolved in 226.8 g deionized H₂O. The organic layer was slowly added to the aqueous layer to avoid precipitation of Ms-FVE. The reaction mixture was suspended via mechanical stirring at 225 rpm for 1 hour. The temperature was increased to 50° C. and stirring continued 2 hours. Then, the temperature was increased to 75° C. and the reaction was allowed to proceed 16 hours, at which time solid particles were observed in the bottom of the reaction vessel. The insoluble particles were separated via filtration over filter paper, then washed with water, methanol, and water again to remove any small molecule contaminants. The product was white, spherical beads (7.5 g, 75%). The beads were stored swollen, except for an aliquot which were dried for thermal characterization.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

### REFERENCES

(1) Banks, R.E.; Smart, B.E.; Tatlow, J. C. Organofluorine Chemistry: Priciples and Comercial Applications; Springer US: Boston, MA, 1994.

(2) Knepper, T. P.; Lange, F. T. Polyfluorinated Chemicals and Transformation Products; Springer Science & Business Media, 2011; Vol. 17.

(3) Kotthoff, M.; Müller, J.; Jürling, H.; Schlummer, M.; Fiedler, D. Perfluoroalkyl and Polyfluoroalkyl Substances in Consumer Products. Environ. Sci. Pollut. Res. 2015, 22 (19), 14546-14559.

(4) Sun, M.; Arevalo, E.; Strynar, M.; Lindstrom, A.; Richardson, M.; Kearns, B.; Pickett, A.; Smith, C.; Knappe, D. R. U. Legacy and Emerging Perfluoroalkyl Substances Are Important Drinking Water Contaminants in the Cape Fear River Watershed of North Carolina. Environ. Sci. Technol. Lett. 2016, 3 (12), 415-419. https://doi.org/10.1021/acs.estlett.6b00398.

(5) Cousins, I. T.; Vestergren, R.; Wang, Z.; Scheringer, M.; Mclachlan, M. S. The Precautionary Principle and Chemicals Management : The Example of Perfluoroalkyl Acids in Groundwater. Environ. Int. 2016, 94, 331-340.

(6) Darrow, L. A.; Groth, A. C.; Winquist, A.; Shin, H.-M.; Bartell, S. M.; Steenland, K. Modeled Perfluorooctanoic Acid (PFOA) Exposure and Liver Function in a Mid-Ohio Valley Community. Environ. Health Perspect. 2016, 124 (8), 1227-1233.

(7) Quaak, I.; de Cock, M.; de Boer, M.; Lamoree, M.; Leonards, P.; van de Bor, M. Prenatal Exposure to Perfluoroalkyl Substances and Behavioral Development in Children. Int. J. Environ. Res. Public Health 2016, 13 (5), 511.

(8) Kataria, A.; Trachtman, H.; Malaga-Dieguez, L.; Trasande, L. Association between Perfluoroalkyl Acids and Kidney Function in a Cross-Sectional Study of Adolescents. Environ. Heal. 2015, 14 (1), 89.

(9) Barry, V.; Winquist, A.; Steenland, K. Perfluorooctanoic Acid (PFOA) Exposures and Incident Cancers among Adults Living near a Chemical Plant. Environ. Health Perspect. 2013, 121 (11-12), 1313-1318.

(10) Melzer, D.; Rice, N.; Depledge, M. H.; Henley, W. E.; Galloway, T. S. Association between Serum Perfluorooctanoic Acid (PFOA) and Thyroid Disease in the US National Health and Nutrition Examination Survey. Environ. Health Perspect. 2010, 118 (5), 686-692.

(11) Chang, E. T.; Adami, H.-O.; Boffetta, P.; Wedner, H. J.; Mandel, J. S. A Critical Review of Perfluorooctanoate and Perfluorooctanesulfonate Exposure and Immunological Health Conditions in Humans. Crit. Rev. Toxicol. 2016, 46 (4), 279-331.

(12) Drinking Water Health Advisory for Perfluorooctanoic Acid (PFOA); 2016.

(13) McCord, J.; Strynar, M. Identification of Per-and Polyfluoroalkyl Substances in the Cape Fear River by High Resolution Mass Spectrometry and Nontargeted Screening. Environ. Sci. Technol. 2019, 53 (9), 4717-4727.

(14) Ross, I.; McDonough, J.; Miles, J.; Storch, P.; Thelakkat Kochunarayanan, P.; Kalve, E.; Hurst, J.; S. Dasgupta, S.; Burdick, J. A Review of Emerging Technologies for Remediation of PFASs. Remediat. J. 2018, 28 (2), 101-126.

(15) Rahman, M. F.; Peldszus, S.; Anderson, W. B. Behaviour and Fate of Perfluoroalkyl and Polyfluoroalkyl Substances (PFASs) in Drinking Water Treatment: A Review. Water Res. 2013, 50, 318-340.

(16) Hopkins, Z. R.; Sun, M.; DeWitt, J. C.; Knappe, D. R. U. Recently Detected Drinking Water Contaminants: GenX and Other Per- and Polyfluoroalkyl Ether Acids. J. Am. Water Works Assoc. 2018, 110 (7), 13-28.

(17) Klemes, A. M. J.; Ling, Y.; Ching, C.; Wu, V.; Helbling, E.; Dichtel, W. R. Reduction of a Tetrafluoroterephthalonitrile-β-Cyclodextrin Polymer to Remove Anionic Micropollutants and Perfluorinated Alkyl Substances from Water. Angew. Chemie Int. Ed. 2019, 58, 12049-12053.

(18) Xiao, L.; Ching, C.; Ling, Y.; Nasiri, M.; Klemes, M. J.; Reineke, T. M.; Helbling, D. E.; Dichtel, W. R. Cross-Linker Chemistry Determines the Uptake Potential of Perfluorinated Alkyl Substances by β-Cyclodextrin Polymers. Macromolecules 2019, 52, 3747-3752.

(19) Klemes, M. J.; Skala, L. P.; Ateia, M.; Trang, B.; Helbling, D. E.; Dichtel, W. R. Polymerized Molecular Receptors as Adsorbents to Remove Micropollutants from Water. Acc. Chem. Res. 2020, No. 53,2314-2324.

(20) Ji, W.; Xiao, L.; Ling, Y.; Ching, C.; Matsumoto, M.; Bisbey, R. P.; Helbling, D. E.; Dichtel, W. R. Removal of GenX and Perfluorinated Alkyl Substances from Water by Amine-Functionalized Covalent Organic Frameworks. J. Am. Chem. Soc. 2018, 140 (40), 12677-12681.

(21) Xiao, L.; Ling, Y.; Alsbaiee, A.; Li, C.; Helbling, D. E.; Dichtel, W. R. β-Cyclodextrin Polymer Network Sequesters Perfluorooctanoic Acid at Environmentally Relevant Concentrations. J. Am. Chem. Soc. 2017, 139, 7680-7692.

(22) Alsbaiee, A.; Smith, B. J.; Xiao, L.; Ling, Y.; Helbling, D. E.; Dichtel, W. R. Rapid Removal of Organic Micropollutants from Water by a Porous β-Cyclodextrin Polymer. Nature 2016, 529 (7585), 190-194.

(23) Ling, Y.; Klemes, M. J.; Xiao, L.; Alsbaiee, A.; Dichtel, W. R.; Helbling, D. E. Benchmarking Micropollutant Removal by Activated Carbon and Porous β-Cyclodextrin Polymers under Environmentally Relevant Scenarios. Environ. Sci. Technol. 2017, 51, 7590-7598.

(24) Cao, F.; Wang, L.; Ren, X.; Sun, H. Synthesis of a Perfluorooctanoic Acid Molecularly Imprinted Polymer for the Selective Removal of Perfluorooctanoic Acid in an Aqueous Environment. J. Appl. Polym. Sci. 2016, 133 (15), 1-10.

(25) Yu, Q.; Deng, S.; Yu, G. Selective Removal of Perfluorooctane Sulfonate from Aqueous Solution Using Chitosan-Based Molecularly Imprinted Polymer Adsorbents. Water Res. 2008, 42, 3089-3097.

(26) Koda, Y.; Terashima, T.; Takenaka, M.; Sawamoto, M. Star Polymer Gels with Fluorinated Microgels via Star—Star Coupling and Crosslinking for Water Purification. ACS Macro Lett. 2015, 4, 377-380.

(27) Koda, Y.; Terashima, T.; Sawamoto, M. Fluorous Microgel Star Polymers: Selective Recognition and Separation of Polyfluorinated Surfactants and Compounds in Water. J. Am. Chem. Soc. 2014, 136, 15742-15748.

(28) Huang, P. J.; Hwangbo, M.; Chen, Z.; Liu, Y.; Kameoka, J.; Chu, K. H. Reusable Functionalized Hydrogel Sorbents for Removing Long- and Short-Chain Perfluoroalkyl Acids (PFAAs) and GenX from Aqueous Solution. ACS Omega 2018, 3 (12), 17447-17455.

(29) Ateia, M.; Pellizzeri, S.; Attia, M. F.; Tharayil, N.; Anker, J. N.; Karan, T. Cationic Polymer for Selective Removal of GenX and Short-Chain PFAS from Surface Waters and Wastewaters at Ng/L Levels. Water Res. 2019, 163.

(30) Ateia, M.; Attia, M. F.; Maroli, A.; Tharayil, N.; Alexis, F. Rapid Removal of Poly- and Perfluorinated Alkyl Substances by Poly(Ethylenimine)-Functionalized Cellulose Microcrystals at Environmentally Relevant Conditions. Environ. Sci. Technol. Lett. 2018, 5 (12), 764-769.

(31) Kumarasamy, E.; Manning, I. M.; Collins, L. B.; Coronell, O.; Leibfarth, F. A. Ionic Fluorogels for Remediation of Per- and Polyfluorinated Alkyl Substances from Water. ACS Cent. Sci. 2020, 6 (4), 487-792.

(32) Valade, D.; Boschet, F.; Améduri, B. Synthesis and Modification of Alternating Copolymers Based on Vinyl Ethers, Chlorotrifluoroethylene, and Hexafluoropropylene. Macromolecules 2009, 42 (20), 7689-7700.

(33) Lee, J.; Lopez, G.; Améduri, B.; Seo, M. Synthesis of Heterograft Copolymers with a Semifluorinated Backbone by Combination of Grafting-through and Grafting-from Polymerizations. Macromolecules 2020.

(34) Wang, P.; Dai, J.; Liu, L.; Dong, Q.; Jin, B.; Bai, R. Xanthate-Mediated Living/Controlled Radical Copolymerization of Hexafluoropropylene and Butyl Vinyl Ether under 60Co γ-Ray Irradiation and Preparation of Fluorinated Polymers End-Capped with a Fluoroalkyl Sulfonic Acid Group. Polym. Chem. 2013, 4 (6), 1760-1764.

(35) Alaaeddine, A.; Boschet, F.; Ameduri, B.; Boutevin, B. Synthesis and Characterization of Original Alternated Fluorinated Copolymers Bearing Glycidyl Carbonate Side Groups. J. Polym. Sci. Part A Polym. Chem. 2012, 50 (16), 3303-3312.

(36) Liu, L.; Lu, D.; Wang, H.; Dong, Q.; Wang, P.; Bai, R. Living/Controlled Free Radical Copolymerization of Chlorotrifluoroethene and Butyl Vinyl Ether under 60Co γ-Ray Irradiation in the Presence of S-Benzyl O-Ethyl Dithiocarbonate. Chem. Commun. 2011, 47 (27), 7839-7841.

(37) Valade, D.; Boschet, F.; Ameduri, B. Grafting Polymerization of Styrene onto Alternating Terpolymers Based on Chlorotrifluoroethylene, Hexafluoropropylene, and Vinyl Ethers, and Their Modification into Ionomers Bearing Ammonium Side-Groups. J. Polym. Sci. Part A Polym. Chem. 2010, 48 (24), 5801-5811.

(38) Santhosh Kumar, K. S.; Ameduri, B. Synthesis and Characterization of Epoxy Functionalized Cooligomers Based on Chlorotrifluoroethylene and Allyl Glycidyl Ether. J. Polym. Sci. PartA Polym. Chem. 2010, 48 (16), 3587-3595.

(39) Mohammad, S. A.; Shingdilwar, S.; Banerjee, S.; Ameduri, B. Macromolecular Engineering Approach for the Preparation of New Architectures from Fluorinated Olefins and Their Applications. Prog. Polym. Sci. 2020, 106, 101255.

(40) Dams, R.; Hintzer, K. Fluorinated Polymers: Volume 2: Applications; 2016.

(41) Boschet, F.; Améduri, B. Copolymers of Chlorotrifluoroethylene: Synthesis, Properties, and Applications. Chem. Rev. 2014, 114 (2), 927-980.

(42) Couture, G.; Ladmiral, V.; Améduri, B. Methods to Prepare Quaternary Ammonium Groups-Containing Alternating Poly(Chlorotrifluoroethylene-Alt-Vinyl Ether) Copolymers. RSC Adv. 2015, 5 (14), 10243-10253.

(43) Hamiye, R.; Alaaeddine, A.; Awada, M.; Campagne, B.; Caillol, S.; Guillaume, S. M.; Ameduri, B.; Carpentier, J.-F. From Glycidyl Carbonate to Hydroxyurethane Side-Groups in Alternating Fluorinated Copolymers. Polym. Chem. 2014, 5 (17), 5089-5099.

(44) Alaaeddine, A.; Hess, A.; Boschet, F.; Allcock, H.; Ameduri, B. Synthesis and Characterization of Novel Alternating Fluorinated Copolymers Bearing Oligo(Ethylene Oxide) Side Chains. J. Polym. Sci. Part A Polym. Chem. 2013, 51 (4), 977-986.

(45) Couture, G.; Campagne, B.; Alaaeddine, A.; Améduri, B. Synthesis and Characterizations of Alternating Co- and Terpolymers Based on Vinyl Ethers and Chlorotrifluoroethylene. Polym. Chem. 2013, 4 (6), 1960-1968.

(46) Alaaeddine, A.; Couture, G.; Ameduri, B. An Efficient Method to Synthesize Vinyl Ethers (VEs) That Bear Various Halogenated or Functional Groups and Their Radical Copolymerization with Chlorotrifluoroethylene (CTFE) to Yield Functional Poly(VE-Alt-CTFE) Alternated Copolymers. Polym. Chem. 2013, 4 (16), 4335-4347.

(47) Li, D.; Liao, M. Study on the Dehydrofluorination of Vinylidene Fluoride (VDF) and Hexafluoropropylene (HFP) Copolymer. Polym. Degrad. Stab. 2018, 152, 116-125.

(48) Li, D.; Liao, M. Dehydrofluorination Mechanism, Structure and Thermal Stability of Pure Fluoroelastomer (Poly(VDF-Ter-HFP-Ter-TFE) Terpolymer) in Alkaline Environment. J. Fluor. Chem. 2017, 201, 55-67.

(49) Couture, G.; Alaaeddine, A.; Boschet, F.; Ameduri, B. Polymeric Materials as Anion-Exchange Membranes for Alkaline Fuel Cells. Prog. Polym. Sci. 2011, 36 (11), 1521-1557.

(50) Ateia, M.; Helbling, D. E.; Dichtel, W. R. Best Practices for Evaluating New Materials as Adsorbents for Water Treatment. ACS Mater. Lett. 2020, No. 2,1532-1544.

(51) Ateia, M.; Alsbaiee, A.; Karanfil, T.; Dichtel, W. Efficient PFAS Removal by Amine-Functionalized Sorbents: Critical Review of the Current Literature. Environ. Sci. Technol. Lett. 2019, 6 (12), 688-695.

(52) Arshady, R. Suspension, Emulsion, and Dispersion Polymerization: A Methodological Survey. Colloid Polym. Sci. 1992, 270 (8), 717-732.

(53) Valade, D.; Boschet, F.; Améduri, B. Synthesis and Modification of Alternating Copolymers Based on Vinyl Ethers, Chlorotrifluoroethylene, and Hexafluoropropylene. Macromolecules 2009, 42 (20), 7689-7700.

1. A fluorinated ionic polymer network comprising a fluoroolefin-vinyl ether copolymer and at least one crosslinking agent, wherein the fluorinated ionic polymer network has the structure of Formula (III): 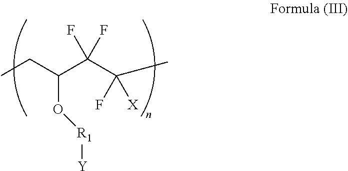
wherein
Y is, in each instance, a crosslinking agent, absent, a leaving group, or a leaving group precursor, provided that in at least one instance, Y is the crosslinking agent, wherein
the crosslinking agent comprised nucleophilic moieties prior to incorporation into the fluorinated ionic polymer network,
the leaving group is selected from the group consisting of halo CN, S-aryl, N₃, O-aryl, and O—SO₂R⁴, wherein R⁴ is lower-alkyl, aryl or aryl lower-alkyl, wherein the alkyl or aryl groups are unsubstituted, or mono- or di- substituted with halides, SO₂R⁴, SOR⁴, COOR⁴, COR⁴, CN, CF₃, or NO₂, and
the leaving group precursor is a group capable of being converted into a leaving group, such as —SH, —OH, —SR⁵, or —OR⁵, wherein R⁵ is a protecting group,
n is an integer from 1-2000,
R¹ is, in each instance, independently chosen from substituted or unsubstituted C1-C10 alkyl, substituted or unsubstituted aryl, substituted heteroaryl, substituted cycloalkyl, wherein the substituted or unsubstituted C1-C10 alkyl may further comprise an ether, amide, ester, amine, thioether, or a combination thereof, and
X is, in each instance, chosen from —F, —Cl, —CF₃, —CF₂CF₃, and —CF₂H.

2. The fluorinated ionic polymer network of claim 1, wherein the crosslinking agent is a heteroaliphatic crosslinking agent comprising nucleophilic moieties, and
the nucleophilic moieties are each independently selected from the group consisting of —OH, —SH, —NH₂, —NHR, —NRₐR_{b}, and a nitrogen-containing heterocycle, where Rₐ and R_{b} are independently selected from the groups alkyl, haloalkyl, alkenyl, alkynyl, cycloalkyl, cycloalkylalkyl, aryl, arylalkyl, heterocyclo, and heterocycloalkyl.

3. The fluorinated ionic polymer network of claim 2, wherein the nucleophilic moieties are —NRₐR_{b}, where Rₐ and R_{b} are alkyl.

4. The fluorinated ionic polymer network of claim 3, wherein the crosslinking agent is selected from the group consisting of N,N,N′,N′-tetramethylethylenediamine, N,N,N′,N″,N″-pentamethyldiethylenetriamine, 1,1,4,7,10,10-hexamethyltriethylenetetramine, and tris[2-(dimethylamino)ethyl]amine, and a combination thereof.

5. The fluorinated ionic polymer network of claim 1, wherein each instance of R¹ is independently chosen from substituted or unsubstituted C1-C10 alkyl

6. The fluorinated ionic polymer network of claim 5, wherein each instance of R¹ is independently chosen from unsubstituted C1-C10 alkyl, and X is Cl or CF₃ and wherein each instance of Y is independently chosen from absent, —O—SO₂R⁴, and —Cl.

7. (canceled)

8. (canceled)

9. The fluorinated ionic polymer network of claim 4, wherein each instance of R¹ is independently chosen from unsubstituted C1-C10 alkyl, X is Cl, and each instance of Y is independently chosen from being absent and a crosslinking agent.

10. The fluorinated ionic polymer network of claim 9, wherein the crosslinking agent is selected from the group consisting of N,N,N′,N′ -tetramethylethylenediamine (TMEDA), tris[2-(dimethylamino)ethyl]amine, 1,1,4,7,10,10-hexamethyltriethylenetetramine, and a combination thereof; R¹ in at least one instance is ethyl, and X is Cl.

11. (canceled)

12. (canceled)

13. The fluorinated ionic polymer network of claim 1, wherein Y is a leaving group selected from the group consisting of halo, CN, S-aryl, N₃, O-aryl, and O—SO₂R⁴, wherein R⁴ is lower-alkyl, aryl or aryl lower-alkyl,
wherein the alkyl or aryl groups are unsubstituted, or mono- or di-substituted with halides, SO₂R⁴, SOR⁴, COOR⁴, COR⁴, CN, CF₃, or NO₂.

14. The fluorinated ionic polymer network of claim 1, wherein Y is a leaving group precursor capable of being converted into a leaving group selected from the group consisting of — SH, —OH, —SR⁵, or —OR⁵, wherein R⁵ is a protecting group.

15. The fluorinated ionic polymer network of claim 2, wherein the nucleophilic moieties are —OH groups, and wherein one or more of the following: (a) the crosslinking agent has a backbone which comprises at least one oxygen atom; (b) the backbone of the crosslinking agent is substituted; (c) wherein the backbone of the crosslinking agent is substituted with —F; and/or (d) the crosslinking agent is 1H,1H,11H,11H-perfluoro-3,6,9-trioxaundecane-1,11-diol or Fluorolink® E 10H.

16. (canceled)

17. (canceled)

18. (canceled)

19. (canceled)

20. (canceled)

21. A method for preparing the fluorinated ionic polymer network of claim 1, the method comprising the step of:
contacting the fluoroolefin-vinyl ether copolymer compound of Formula (I) with at least one crosslinking agent, wherein the compound of Formula (I) is 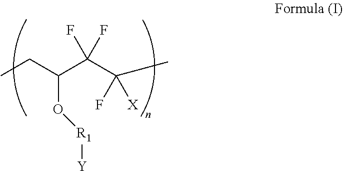
wherein
n is an integer from 1-2000,
each instance of R¹ is independently chosen from substituted or unsubstituted C1-C10 alkyl, substituted or unsubstituted aryl, substituted heteroaryl, and substituted cycloalkyl, each instance of X is selected from the group consisting of —F, —Cl, —CF₃, —CF₂CF₃, and —CF₂H, and
each instance of Y is a leaving group selected from halo, CN, S-aryl, N₃, O-aryl, and O—SO₂R⁴, wherein R⁴ is lower-alkyl, aryl, or aryl lower-alkyl.

22. The method of claim 21, wherein in each instance of R¹ is independently selected from a substituted C1-C10 alkyl and an unsubstituted C1-C10 alkyl, and Y is halo or —O—SO₂R⁴.

23. (canceled)

24. The method of claim 21, further comprising a step for preparation of the fluorinated ionic polymer network, wherein the step comprises polymerization of at least two separate olefin containing molecules.

25. A method for removing a polyfluorinated alkyl compound from water, the method comprising the steps of capturing the polyfluorinated alkyl compound from the water with the fluorinated ionic polymer network of claim 1.

26. The method of claim 25, further comprising the step of removing the fluorinated ionic polymer network comprising the sorbed polyfluorinated alkyl compound from the water.

27. The method of claim 26, further comprising the step of separating the sorbed polyfluorinated alkyl compound from the fluorinated ionic polymer network.

28. The method of claim 125, wherein the crosslinking agent is heteroaliphatic and the nucleophilic moieties are each independently selected from the group consisting of —OH, —NH₂, —NHR, and —NRₐR_{b}, where Rₐ and R_{b} are alkyl.

29. The method of claim 28, wherein the crosslinking agent is selected from N,N,N′,N′-tetramethylethylenediamine, tris [2-(dimethylamino)ethyl]amine, 1,1,4,7,10,10-hexamethyltriethylenetetramine, and a combination thereof; and wherein in the compound of Formula (I), in each instance of R1 is independently chosen from unsubstituted C1-C10 alkyl, and X is Cl or CF₃.

30. (canceled)

31. The method of claim 25, wherein the crosslinking agent is selected from N,N,N′,N′-tetramethylethylenediamine, tris [2-(dimethylamino)ethyl]amine, 1,4,7,10,10-hexamethyltriethylenetetramine and a combination thereof,
R¹ in at least one instance is ethyl, and
X is CF₃ or Cl.
